(19) United States
(12) Patent Application Publication
(10) Pub. No.: US 2016/0142453 A1
(43) Pub. Date: May 19, 2016

(54) FEATURES AND OPTIMIZATIONS FOR PERSONAL COMMUNICATION DEVICE BASED PUBLIC ADDRESSING SYSTEM

(71) Applicant: Qualcomm Incorporated, San Diego, CA (US)

(72) Inventors: Karthika Paladugu, San Diego, CA (US); Soham Vikrambhai Sheth, San Diego, CA (US); Arungundram Chandrasekaran Mahendran, San Diego, CA (US)

(21) Appl. No.: 14/831,800

(22) Filed: Aug. 20, 2015

Related U.S. Application Data
(60) Provisional application No. 62/080,200, filed on Nov. 14, 2014.

(51) Int. Cl. H04L 29/06; H04R 3/00; H04R 27/00

(52) U.S. Cl. CPC H04L 65/4038; H04R 27/00; H04R 3/005; H04L 65/1066; H04R 2420/07; H04R 2499/11

(57) ABSTRACT

Systems and methods are described herein, a method including, but not limited to, receiving, by a client, audio data and uplink data simultaneously from one of a plurality of Personal Communication Devices (PCDs) connected to the client. The uplink data includes at least one of device information and session identifier. The client sends downlink data to each of the plurality of PCDs based on the uplink data. The client further sends the audio data to the PA system for sounding.

### CROSS-REFERENCE TO RELATED PATENT APPLICATIONS

The present application claims the benefit of U.S. Provisional Patent Application No. 62/080,200 filed on Nov. 14, 2014, the disclosure of which is expressly incorporated herein by reference in its entirety. This application relates to application Ser. No. 14/213,445, filed on Mar. 14, 2014, which claims priority to PCT/US2015/019533 filed Mar. 9, 2015, both which are incorporated herein by reference in their entireties. This application also relates to attorney docket number 150699U1, titled FEATURES AND OPTIMIZATIONS FOR PERSONAL COMMUNICATION DEVICE BASED PUBLIC ADDRESSING SYSTEM, filed on Aug. 20, 2015 which is incorporated herein by reference in its entirety. This application also relates to application Ser. No. 14/804,116, filed on Jul. 20, 2015, which is incorporated herein by reference in its entirety. This application also relates to U.S. Provisional Patent Application No. 62/156,841, filed on May 4, 2015, which is incorporated herein by reference in its entirety.

### BACKGROUND

1. Field

The disclosure relates, generally, to public addressing (PA) systems and methods and, in particular embodiments, to systems and methods in which one or more personal communication devices (PCDs) are operated as a microphone for a PA system. Further embodiments relate to a PCD configured to operate with such systems and methods.

2. Background

PA systems can be used in various contexts, including conferences, meetings, seminars, concerts, and other events or activities, to amplify an audio input, such as a person's voice, a group of peoples' voices, music, or other sounds, and broadcasts the amplified sound through one or more electronic speaker devices, to an audience or persons attending the event or activity. For example, one or more hosts or attendees of such an event or activity may desire to access the PA system (as a speaker) to speak, give lectures, add comments, ask or answer questions, or the like. A microphone may be passed or delivered to that host or attendee, to allow the host or attendee to speak through the PA system. Passing and delivering of a microphone through an audience or group of attendees can be inconvenient, and can result in significant pauses between speakers of an audio program. To avoid the need to pass and deliver microphones through an audience, PCDs (such as, but not limited to, mobile phones) may be implemented to interface with the PA system in a manner such that one or more selected PCDs may act as a microphone for the PA system. Given the popularity of PCDs in modern society, hosts or attendees of an event or activity may likely carry their own PCDs. By configuring such PCDs and the PA system to interface, the hosts or attendees may employ their own PCDs as a microphone for the PA system.

However, when using a PCD as a microphone in a PA system, feedback (also known as howling) can occur when a sound that has been captured, amplified, and broadcasted by the PA system is recaptured by the microphone of the PCD and amplified/broadcasted again. In this manner, a loop is created such that the sound is continuously being re-amplified over a short period of time. Such loops produce, with the speakers of the PA system, a high-pitched (howling) sound that can be very unpleasant to the audience or attendees. PCDs with sensitive microphones can tend to create feedback when used as microphones to the PA systems.

Moreover, feedback can be more likely to occur, if audio signals (from multiple PCDs) having different amplitude ranges are fed into the input of the PA system. Conventional PA systems configured to suppress feedback for a first amplitude range, may not be capable of suppressing feedback for a second amplitude range which is greater than the first amplitude range. Thus, the conventional PA systems may not support feedback suppression for PCDs that output audio signals to the PA systems at different amplitude ranges.

One factor contributing to audio signals having different amplitude ranges is that PCDs may include hardware (such as, but not limited to, microphones) with different performance characteristics. This is at least partially because the various PCDs carried by audience members or attendees of an event or activity may be made by different manufacturers, may be different models from the same manufacturer, or may contain hardware from different component suppliers, such that the hardware may have different performance characteristics.

Another factor is that the speaking habits of different PCD users tend to be different from each other. For example, some users may speak loudly (or keep the PCD close) while other users may speak softly (or keep PCD far). Yet another factor is that different electronic speaker devices in a PA system may have different performance characteristics related to outputting sound. Some other factors include, but are not limited to, the speaking user's (speaker's) distance from the electronic speaker devices, the PCD microphone's frequency response, the sensitivity of the PCD microphone, the direction of the PCD microphone relative to the user, the acoustics of the room or area in which the PA system broadcasts, the direction of the electronic speaker devices with respect to speaking user's (speaker's) location, and/or the like.

### SUMMARY

Systems and methods for managing, controlling, and optimizing a public addressing (PA) system are described herein, where source data for the PA system is being captured by a plurality of personal communication devices (PCDs). While systems and methods of particular embodiments relate to audio data and PA systems, one of ordinary skill in the art should appreciate that further embodiments may be employed in other applications relating to data processing optimization, and the like. In particular, latency improvement processes, howling suppression processes, service set identifier optimization processes, and device-to-device optimization processes described herein for PA system and method embodiments, may be implemented for other suitable systems and methods processing other suitable data types.

In some embodiments, a method for data communication in a PA system, including: receiving, by a client, host, or server, audio data and uplink data simultaneously from one of a plurality of PCDs connected to the client. The uplink data includes at least one of device information and session identifier. The method further includes sending, by the client, host, or server, downlink data to each of the plurality of PCDs based on the uplink data, and sending, by the client, host, or server, the audio data to the PA system for sounding.

In some embodiments, the PA system is at least one of (1) a Peer-to-Peer (P2P) system without a centralized server or host, or (2) a system with centralized control by the server or the host.

In some embodiments, the method further includes establishing, by the client, host, or server, an active participant session with a first PCD of the plurality of PCDs; receiving, by the client, host, or server, a request to share from a second PCD of the plurality of PCDs; negotiating, by the client, host, or server with the first and second PCDs, access parameters after receiving the request to share; and receiving, by the client, host, or server, the audio data based on the negotiated access parameters from both the first PCD and the second PCD.

In some embodiments, the method further includes sending, by the client to a host, a request for permission to share in response to receiving the request to share from the second PCD; negotiating the access parameters in response to receiving, by the client, an indication indicating permission from the host to share the client; and accepting, by the client, a request for permission to share from a third PCD without negotiating the access parameters based on user input or automatically.

In some embodiments, the method further includes updating, by the client with the host, a session status. The audio data from the first PCD and the second PCD is received by the client in response to sessions status being updated.

In some embodiments, the method further includes combining, by the client, host, or server, the audio data received from both the first PCD and the second PCD; outputting the combined audio data to the PA system for sounding, and scaling, by the client, host, or server, the audio data received from both the first PCD and the second PCD before combining the audio data.

In some embodiments, the method further includes selecting, by the client, host, or server, the one of the plurality of PCDs from the plurality of PCDs, starting, by the client, host, or server, a data inactivity timer that counts down when energy associated with the audio data of the selected PCD is below a predetermined threshold, notifying, by the client, host, or server, that the data inactivity timer is about to expire, selecting, by the client, host, or server, another one of the plurality of PCDs, automatically or based on user input, when the data inactivity timer expires, and continuing to receive, by the client, host, or server, the audio data of the selected PCD when time on the data inactivity timer is unexpired.

In some embodiments, the method further includes notifying, by the client, host, or sever, the one of the plurality of PCDs to disconnect from the active participant session when the energy is below a predetermined threshold, and either of: requesting, by the client, host, or server, the one of the plurality of PCDs to mute a microphone of the one of the plurality of PCDs when the energy is below a predetermined threshold, or muting, by the one of the plurality of PCDs, the microphone without any indication from the client, host, or server.

In some embodiments, the method further includes increasing, by the client, host, or sever, a time left on the data inactivity timer when the energy associated with the audio data is above a predetermined threshold, and freezing, by the client, host, or sever, the time left on the data inactivity timer when the energy associated with the audio data is above a predetermined threshold.

In some embodiments, the method further includes dropping, by the client, host, or sever, audio data from another one of the plurality of PCDs before the data inactivity timer expires.

In some embodiments, the method further includes receiving, by the client, host, or sever, an indication from the selected PCD to release a floor, and selecting another one of the plurality of PCDs in response to receiving the indication either automatically or based on user input.

In some embodiments, the method further includes assigning, by the client, host, or sever, a unique code for each of the plurality of PCDs, the unique codes indicate approved devices, receiving, by the client, host, or sever, the audio data and the uplink data with the unique code associated with the one of the plurality of PCDs, and processing, by the client, host, or sever, the audio data and the uplink data when the received unique code is determined to be associated with one of the approved devices.

In some embodiments, the method further includes determining, by the client, host, or sever, an Internet Protocol (IP) address for each of the plurality of PCDs, the IP address indicate approved devices, receiving, by the client, host, or sever, the audio data and the uplink data with the IP address with the one of the plurality of PCDs, and processing, by the client, host, or sever, the audio data and the uplink data when the received IP address is determined to be associated with one of the approved devices.

In some embodiments, the method further includes redirecting the audio and the uplink data from one port to another port of the client.

In some embodiments, the method further includes receiving, by the client from a host, a request to reset, and resetting the client in response to the request to reset.

In some embodiments, the method further includes receiving, by the client from a host, a request to modify configurations, and modifying the configurations of the client in response to the request to modify. The configurations modified include opening a socket with a different port number.

In some embodiments, the downlink data includes at least one of a presenter's biography, presentation material, reference sites, advertisement based on the presenter's information, or advertisement based on the presentation content. The presenter is a user of the one of the plurality of PCDs.

In some embodiments, the method further includes receiving, by the client, host, or sever from the one of the plurality of PCDs, the uplink data stored on the one of the plurality of PCDs. The uplink data received by the client correspond to the downlink data.

In some embodiments, the uplink data includes at least one of audio message, live questions, instance messages, user profile information, profile picture, or biography.

In some embodiments, the uplink data include at least one of a maker of the one of the plurality of PCDs, model of the one of the plurality of PCDs, name of a user of the one of the plurality of PCDs, affiliation of the user of the one of the plurality of PCDs, or audio speech converted into text.

In some embodiments, the client includes a plurality of client devices, each client device associated with a separate geographical location, the method further includes associating the one of the plurality of PCDs with one of the plurality of client devices based on the session identifier.

In some embodiments, the session identifier is a request to join a session at a desired geographical location as indicated by the session identifier.

In some embodiments, the method further includes providing, by a server, a client identifier identifying the client device associated with the desired geographical location indicated by the session identifier.

In some embodiments, the one of the plurality of PCDs is not within the boundaries of the desired geographical location.

In some embodiments, the method further includes receiving a floor request from two or more of the plurality of PCDs, queuing the floor requests based on time received, determining a position in queue of the one of the plurality of PCDs; and sending the position to the one of the plurality of PCDs for displaying to a user of the one of the plurality of PCDs.

In various embodiments, a system for data communication in a PA system, including means for receiving audio data and uplink data simultaneously from one of a plurality of PCDs. The uplink data includes at least one of device information and session identifier. The PA system further includes means for sending downlink data to each of the plurality of PCDs based on the uplink data and means for sending the audio data to the PA system for sounding.

According to some embodiments, a non-transitory computer-readable medium including computer-readable instructions such that, when executed, causes a processor to: receive audio data and uplink data simultaneously from one of a plurality of PCDs. The uplink data includes at least one of device information and session identifier. The processor is further configured to send downlink data to each of the plurality of PCDs based on the uplink data and send the audio data to the PA system for sounding.

In some embodiments, the processor is further configured to establish an active participant session with a first PCD of the plurality of PCDs, receive a request to share from a second PCD of the plurality of PCDs, negotiate with the first and second PCDs access parameters after receiving the request to share, and receive the audio data based on the negotiated access parameters from both the first PCD and the second PCD.

In some embodiments, the processor is further configured to send a request for permission to share in response to receiving the request to share from the second PCD, and negotiate the access parameters in response to receiving an indication indicating permission from the host to share the client.

In some embodiments, the processor is further configured to update a session status. The audio data from the first PCD and the second PCD is received in response to sessions status being updated.

### BRIEF DESCRIPTION OF THE DRAWINGS

FIG. 1 is a diagram illustrating an audio signal adjustment system according to various embodiments.

FIG. 2 is a block diagram illustrating an example of a PCD for implementation within the audio signal adjustment system according to various embodiments.

FIG. 3 is a block diagram illustrating an example of a host for implementation within the audio signal adjustment system according to various embodiments.

FIG. 4 is a block diagram illustrating an example of a client for implementation within the audio signal adjustment system according to various embodiments.

FIG. 5 is a diagram illustrating examples of audio signals that may be adjusted according to various embodiments.

FIG. 6 is a diagram illustrating examples of interaction between components of the audio signal adjustment system according to various embodiments.

FIG. 7 illustrates a process flowchart of a method for manually adjusting the audio signals according to various embodiments.

FIG. 8 illustrates a process flowchart of a method for automatically adjusting the audio signals according to various embodiments.

FIGS. 9A-9C are block diagrams illustrating adjustment requests according to various embodiments.

FIGS. 10A-10C illustrate process flowcharts of methods performed in response to adjustment requests according to various embodiments.

FIG. 11 illustrates a process flowchart of a method for adjusting the audio signals in response to two or more adjustment requests according to various embodiments.

FIG. 12 illustrates a process flowchart of a method for adjusting audio signals by a PCD according to various embodiments.

FIG. 13 illustrates an example of a gain adjustment user interface 1300 according to various embodiments.

FIG. 14A is a process flow chart illustrating a first example of an initial gain assignment method according to various embodiments.

FIG. 14B is a process flow chart illustrating a second example of an initial gain assignment method according to various embodiments.

FIG. 14C is a process flow chart illustrating a third example of initial gain assignment method according to various embodiments.

FIG. 15A is a process flowchart illustrating an example of a generalized connectivity selection method according to various embodiments.

FIG. 15B is a process flowchart illustrating an example of a SSID-based connectivity selection method according to various embodiments.

FIG. 16A is a process flowchart illustrating an example of a device-to-device (D2D) link establishing method according to some embodiments.

FIG. 16B is a system diagram illustrating an example of a D2D link system according to various embodiments.

FIG. 17 is a process flowchart illustrating an example of a floor control method according to various embodiments.

FIG. 18 is a process flowchart illustrating an example of an alternative floor control method according to various embodiments.

FIG. 19A is a process flowchart illustrating an example of a first jamming prevention method according to some embodiments.

FIG. 19B is a process flowchart illustrating an example of a second jamming prevention method according to some embodiments.

FIG. 19C is a process flowchart illustrating an example of a third jamming prevention method according to some embodiments.

FIG. 20 is a process flowchart illustrating an example of a data collection method according to various embodiments.

FIG. 21 is an example of a screen shot 2100 informing the user of the PCD the signal strength is too low.

FIG. 22 is a process flowchart illustrating an example of multiple session management method according to various embodiments.

FIG. 23 is diagram illustrating an example of a call flow method according to various embodiments.

FIG. 24 is a diagram illustrating an example of a multiple PCD shared access processing according to various embodiments.

FIG. 25 is a process flowchart illustrating an example of a latency optimization process according to various embodiments.

FIG. 26 is a process flowchart illustrating an example of a power-saving mode activation process according to various embodiments.

FIG. 27A is a process flowchart illustrating an example of a data packet loss optimization method according to various embodiments.

FIG. 27B is a diagram illustrating an example of a redundant transmission scheme with a same number of packets being transmitted at each bundle.

FIG. 27C is a diagram illustrating an example of a redundant transmission scheme with dynamically changing numbers of packets being transmitted at each bundle.

FIG. 28 is a process flowchart illustrating an example of a data communication method according to various embodiments.

### DETAILED DESCRIPTION

In general, various embodiments relate to systems and methods for audio signal adjustment for a public addressing (PA) system, in which personal communication devices (PCDs) are employed as microphones. Particular embodiments relate to systems and methods of manually and/or automatically adjusting audio signal for a PA system, to suppress or otherwise manage feedback in the PA system. Further embodiments relate to PA systems that include such systems and methods, and PCDs configured to interface in such PA systems.

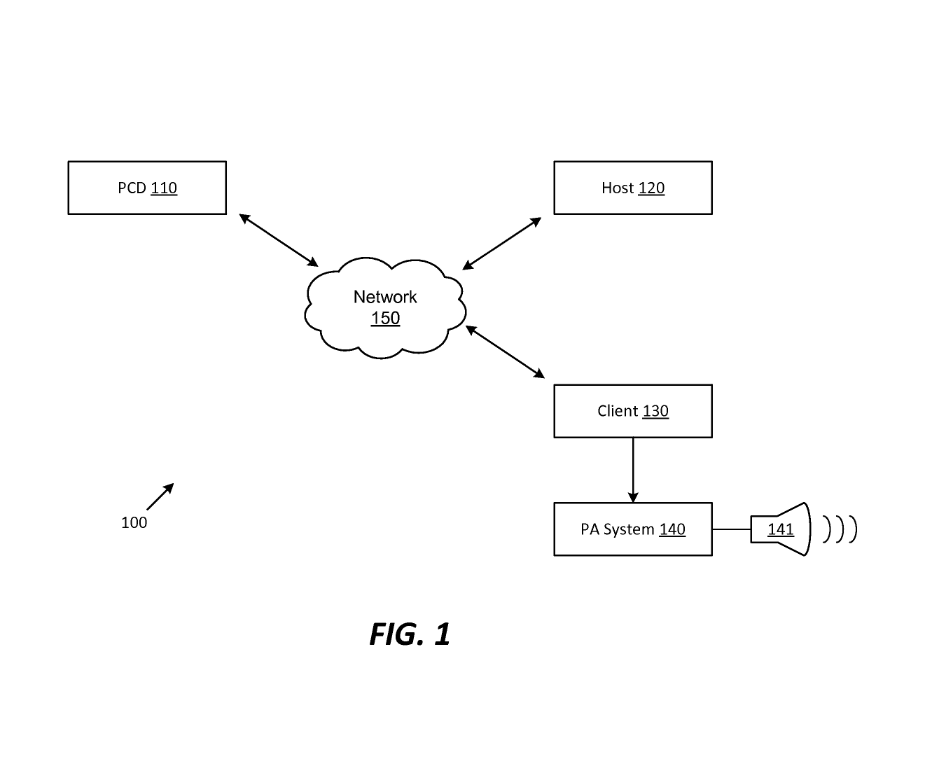

Referring to FIG. 1, a system 100 is illustrated in accordance with various embodiments. The system 100 may include or operate with one or more PCDs 110 (where one PCD 110 is shown in FIG. 1) connected for communication on a network 150. The system 100 may further include a host 120, a client 130, and a PA system 140. The PA system 140 may include at least one electronic speaker device 141 configured to broadcast sound. In particular embodiments, the PA system 140 may include, but is not limited to, a home-theater system, an ad-hoc PA system, a karaoke system, or other audio output system that includes at least one electronic speaker device or other audio output device. In some embodiments, the one or more PCDs 110, the host 120, and the client 130 may be connected for communication with one another, through the communication network 150. The network 150 may provide for data transmission between two or more of the components (such as, but not limited to, the PCD 110, the host 120, the client 130, and the PA system 140) of system 100. The network 150 may be any suitable wired or wireless communication network. The client 130 and the PA system 140 may be connected to each other through a wired or wireless connection or network. In particular embodiments, the PCD 110, the host 120, the client 130, and the PA system 140 may be connected to each other through the same network 150, or through multiple, separate or interconnected networks or connections.

In some embodiments, each of the components 110, 120, 130, 140 may be provided in a separate processing device (such as, but not limited to, provided in a separate device or housed in a separate device housing having its own processor). Providing each of the components 110, 120, 130, 140 in a separate device may provide finer granularity. As the total amount of processing of the system 100 is shared by multiple components 110, 120, 130, 140, the overall efficiency of audio signal adjustment may be improved given that the finer granularity can lead to shorter execution time.

In other embodiments, two or more of the components 110, 120, 130, 140 may be provided by the same device. In one example, the host 120 and the client 130 may be provided in one device (such as, but not limited to, a smart phone or a tablet). In yet another example, the client 130 and the PA system 140 may be provided in one device (such as, but not limited to, the PA system 140). In yet another example, the PCD 110 and the host 120 may be provided in one device (such as, but not limited to, the PCD 110). In yet another example, the PCD 110 and the client 130 may be provided in one device (such as, but not limited to, the PCD 110). In yet another example, the PCD 110, the host 120, and the client 130 may be provided in one device (such as, but not limited to, the PCD 110). Those examples are for illustrative purposes and are not meant to provide an exhaustive list. An advantage associated with providing two or more of the components 110, 120, 130, 140 in one (a common) device is that such components may utilize greater processing power and memory capacity of the device. For example, the processing capabilities of some modern PCDs (such as, but not limited to, smartphones) can allow such devices to implement two or more of the components 110, 120, 130, 140.

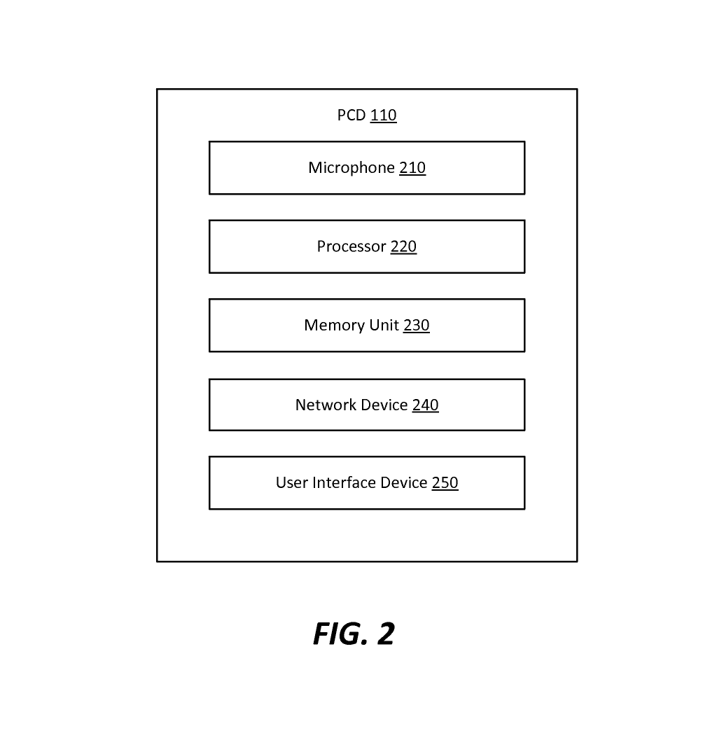

Referring to FIGS. 1-2, an example of the PCD 110 is illustrated in accordance with various embodiments. In various embodiments, the PCD 110 (also known as a source device) may be an electronic mobile device configured to capture sound, process the sound, output audio signal representing the sound to other components, and/or the like. In addition, the PCD 110 may be configured to adjust the audio signal. Examples of the PCD 110 may include, but are not limited to, smartphones (mobile phones), pagers, tablets, PDAs, any mobile computing systems, and/or the like. The PCD 110 may include at least one microphone 210, at least one processor 220, at least one memory unit 230, at least one network device 240, and at least one user interface device 250.

In some embodiments, the at least one microphone 210 may be configured to capture sound from a user of the PCD 110, as the user speaks. In some embodiments, the at least one microphone 210 may be integrated with the PCD 110 or otherwise housed inside of a housing of the PCD 110. In other embodiments, the at least one microphone 210 may be an auxiliary microphone not integrated with the PCD 110, but operatively coupled to the PCD 110 through a wired or wireless connection. In some embodiments, the at least one microphone 210 may be an omnidirectional microphone that may be configured to capture sound from any direction. In some embodiments, the at least one microphone 210 may be a unidirectional microphone that may be configured to capture sound from one, predefined direction. In some embodiments, the at least one microphone 210 may be a microphone of any other polarization pattern. In the case that the at least one microphone 210 may be configured to capture sound from a plurality of directions, the PCD 110 may be configured to deactivate capturing sound from at least one direction of the plurality of directions.

In some embodiments, the at least one microphone 210 may be a plurality of microphones having the same polarization pattern (such as, but not limited to, all of the plurality of microphones may be unidirectional microphones, or all of the plurality of microphones may be omnidirectional microphones). In some embodiments, at least two microphones of a plurality of microphones 210 may have different polarization patterns (for example, if the plurality of microphones include three microphones, two of the three microphones may be omnidirectional microphones and the other microphone may be a unidirectional microphone).

In some embodiments, the at least one processor 220 may be operatively coupled to the at least one memory unit 230 for processing the audio signal. For example, the at least one processor 220 and the at least one memory unit 230 may be configured to perform functions of the PCD 110 as described in the disclosure. In some embodiments, the at least one processor 220 and the at least one memory unit 230 may also be used for processes of the PCD 110 that are unrelated to processing audio signal for the PA system 140.

In some embodiments, the network device 240 may be configured for accessing the communication network 150 such that data may be transmitted via the communication network 150 to and from the PCD 110. In some embodiments, the network device 240 may be a wireless device of the PCD 110, such as a wireless local area network (WLAN) device, wireless wide area network (WWAN) device, personal area network (PAN) device, and/or the like. In other embodiments, the network device 240 may allow for a wired connection to the communication network 150 or other components of the system 100.

In some embodiments, the user interface device 250 may be configured to provide information to the user and/or to accept user input. The user may control the PCD 110 with the user interface device 250. The user interface device 250 may include at least one display for graphical user interface (GUI). The user interface device 250 may also include at least one user input device, such as, but not limited to, a touch screen, a keyboard, a mouse, and/or the like.

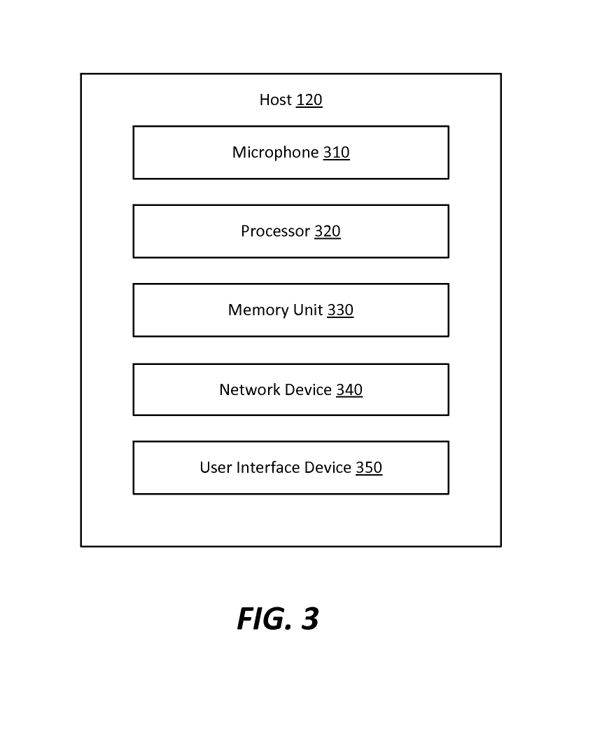

Referring to FIGS. 1-3, an example of the host 120 is illustrated in accordance with various embodiments. In various embodiments, the host 120 (also known as a moderator device) may be an electronic device that allows control and regulation of various aspects of the system 100. For example, the host 120 may provide access to the PA system 140 to prospective users (and their PCDs 110), control duration of the access, terminate the access, enable multiple users to access the PA system 140 concurrently, and/or the like. In particular embodiments, the host 120 may include but is not limited to, a desktop computer, a laptop computer, a PCD, a system on chip, a tablet, a pager, a dongle, and/or the like. The host 120 may include at least one microphone 310, at least one processor 320, at least one memory unit 330, a network device 340, and an user interface device 350.

The host 120 may be configured to suppress feedback by generating an indication (embodied in a signal sent to the client 130, the PCD 110, and the like) to suppress feedback and/or to adjust (such as, but not limited to, increase or decrease) the volume of the outputted sound. In some embodiments, the host 120 may dynamically and remotely control various parameters of the PCD 110, the client 130, or the PA system 140 (or any combination thereof). In some embodiments, the host 120 may be manually operated by an operator (such as, but not limited to, a moderator) to control various aspects of the system 100. In some embodiments, the host 120 may be configured to control various aspects of the system 100 automatically, without any manual input.

In some embodiments, the at least one processor 320 may be operatively coupled to the at least one memory unit 330 for adjusting audio signal. For example, the at least one processor 320 and the at least one memory unit 330 may be configured to perform functions of the host 120 as described in the disclosure. In some embodiments, the at least one processor 320 and the at least one memory unit 330 may also be used for processes of the host 120 that are unrelated to processing audio signal for the PA system 140.

In some embodiments, the network device 340 may be configured for accessing the communication network 150 so that data may be transmitted via the communication network 150 to and from the host 120. In some embodiments, the network device 340 may be a wireless device of the host 120, such as a wireless local area network (WLAN) device, wireless wide area network (WWAN) device, personal area network (PAN) device, and/or the like. In other embodiments, the network device 340 may allow for a wired connection to the communication network 150 or other components of the system 100.

In some embodiments, the user interface device 350 may be configured to provide information to the operator and/or to accept operator input. The user interface device 350 may include at least one display for graphical user interface (GUI). The user interface device 350 may also include at least one user input device, such as, but not limited to a touch screen, a keyboard, a mouse and/or the like. The user interface 350 may support interaction with the operator, i.e., the operator may indicate, through the user interface, whether a triggering event (such as, but not limited to, feedback or insufficient output volume) has occurred.

In some embodiments, the host 120 may be configured to automatically detect, with the at least one microphone 310, whether a triggering event has occurred. In some embodiments, the at least one microphone 310 may be integrated with the host 120 or otherwise contained inside of a housing of the host 120 (such as the same housing that contains the processor 320, memory unit 330, network device 340 and user interface device 350). In some embodiments, the at least one microphone 310 may be an auxiliary microphone not integrated with the host 120, such that the at least one microphone 310 may be operatively coupled to the host 120 in any suitable manner. In some embodiments, the at least one microphone 310 may be an omnidirectional microphone that may capture sound from any direction. In some embodiments, the at least one microphone 310 may be a unidirectional microphone that may capture sound in only one direction. In some embodiments, the at least one microphone 310 may be a microphone of any other polarization pattern. In some embodiments, at least two of a plurality of microphones have different polarization patterns. For example, the plurality of microphones may include three microphones, where two of the three microphones may be omnidirectional microphones, and the other microphone may be a unidirectional microphone. In other embodiments, the at least one microphone 210 may be a plurality of microphones having the same polarization pattern (such as, but not limited to, where all of the plurality of microphones may be unidirectional microphones, or all of the plurality of microphones may be omnidirectional microphones).

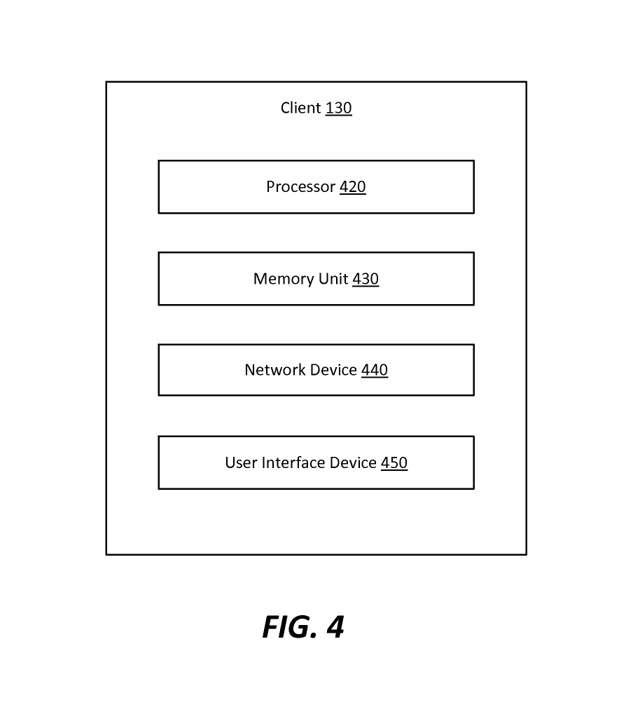

Referring to FIGS. 1-4, an example of the client 130 is illustrated in accordance with various embodiments. In various embodiments, the client 130 (also known as a sink device) may be an electronic device that serves as an intermediary between the PCD 110, the host 120, and the PA system 140. For example, the client 130 may be connected to one or more (or each) of the PCD 110 (which may transmit audio signal to the client 130 via the network 150), the host 120 (which may transmit adjustment requests to the client 130), and the PA system 140 (which may broadcast the audio signal provided by the client 130). In particular embodiments, the client 130 may include, but is not limited to, a desktop computer, a laptop, a PCD, a system on chip, a tablet, a pager, a dongle, and/or the like. In some embodiments, the client 130 may include at least one processor 420, at least one memory unit 430, a network device 440, and an user interface device 450. In further embodiments, the client 130 may further include at least one microphone (not shown).

In some embodiments, the at least one processor 420 may be operatively coupled to at least one memory unit 430 for processing audio signal and for adjustment request processing. For example, the at least one processor 420 and the at least one memory unit 430 may be configured to perform functions of the client 130 as described in the disclosure. In some embodiments, the at least one processor 420 and the at least one memory unit 430 may also be used for processes of the client 130 that are unrelated to processing audio signal for the PA system 140.

In some embodiments, the network device 440 may be configured for accessing the network 150 so data may be transmitted via the network 150 to and from the client 130. In some embodiments, the network device 440 may be a wireless device of the client 130, such as a wireless local area network (WLAN) device, wireless wide area network (WWAN) device, personal area network (PAN) device, and/or the like. In other embodiments, the network device 440 may allow for a wired connection to the network 150 or other components of the system 100.

In some embodiments, the user interface device 450 may be configured to provide information to the user and/or to accept user input. The user interface device 450 may include at least one display for graphical user interface (GUI). The user interface device 450 may also include at least one user input device, such as, but not limited to a touch screen, a keyboard, a mouse, and/or the like. The user interface 450 may support interaction with the user and/or the operator, i.e., the user or the operator may indicate, through the user interface, whether a triggering event (such as, but not limited to, feedback or insufficient output volume) has occurred.

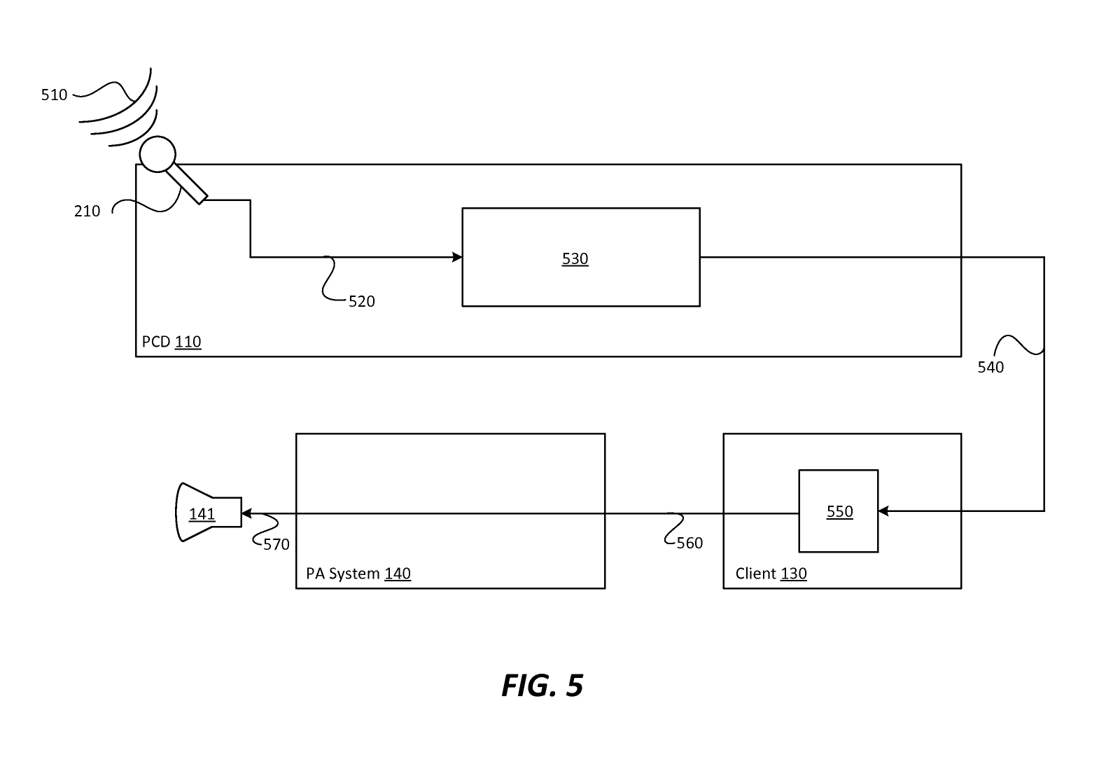

Referring to FIGS. 1-5, one or more of the PCD 110, the client 130, and the PA system 140 may be configured to adjust the audio signals to manage feedback by the system 100. For instance, in some embodiments, the amplitude of the audio signals may be scaled by one or more of the components (such as, but not limited to, the PCD 110, the client 130, and the PA system 140). In some embodiments, frequency ranges or sound-capturing directions of the microphone 210 may be adjusted to suppress feedback.

In some embodiments, sound 510 may be captured by the at least one microphone 210 of the PCD 110 from at least one sound-capturing direction. The at least one microphone 210 may be configured to capture sound from some or all accessible directions depending on the polarization of the microphone 210. In some embodiments, the at least one microphone 210 may be configured to deactivate in (or otherwise ignore) at least one sound-capturing direction (or otherwise to change the polarization of the microphone 210). In some embodiments, the at least one microphone 210 may be a plurality of microphones. The PCD 110 also may selectively deactivate one or more of the plurality of microphones that are capturing sound 510. By deactivating sound-capturing from one or more (or all) directions that generate feedback, the at least one microphone 210 may capture as much sound 510 from the user as possible while still suppressing feedback.

In some embodiments, the microphone 210 may output a microphone signal 520 (such as, but not limited to, corresponding to the captured sound 520). In some embodiments, the microphone signal 520 may be provided to at least one processing unit 530 of the PCD 110 to adjust the microphone signal 520, for example, to manage feedback, adjust volume, and/or the like. The processing unit 530 may include the at least one processor 220 and the at least one memory unit 230. In some embodiments, an insufficient output volume is detected (such as, but not limited to, by the host 120 or the operator thereof) and, in response, the amplitude of the microphone signal 520 may be increased, thus increasing the output volume. In some embodiments, a feedback is detected and, in response, the amplitude of the microphone signal 520 may be decreased, thus decreasing the volume of the outputted sound and managing feedback. In some embodiments, the processing unit 530 may be configured to selectively filter out at least one frequency range in which feedback is occurring. In some embodiments, the processing unit 530 may perform the function of at least one high-pass filter, at least one band-pass filter, at least one low-pass filter, at least one band-stop filter, and/or the like.

In some embodiments, the PCD 110 may output PCD output signal 540 (such as, but not limited to, corresponding to the microphone signal 520). In some embodiments, in response to a detection of an insufficient output volume, the amplitude of the PCD output signal 540 may be increased, thus increasing the volume of the outputted sound. In some embodiments, in response to a detection of feedback, the amplitude of the PCD output gain 540 may be decreased, thus decreasing the volume of the outputted sound and reducing feedback. In some embodiments, the processing unit 530 of the PCD 110 may be configured to adjust the PCD output signal 540.

In some embodiments, the client 130 may output a client output signal 560 (such as, but not limited to, corresponding to the PCD output signal 540). In some embodiments, the PCD output signal 540 may be provided to at least one client processing unit 550 of the client 130 to adjust the PCD output signal 540, for example, to manage feedback, adjust volume, and/or the like. The client processing unit 550 may include the at least one processor 420 and the at least one memory unit 430. In some embodiments, in response to a detection of an insufficient output volume, the client processing unit 550 may increase the amplitude of the PCD output signal 540, thus increasing the volume of the outputted sound. In some embodiments, in response to a detection of feedback, the client processing unit 550 may decrease the amplitude of the PCD output signal 540, thus decreasing the volume of the outputted sound and reducing feedback. In some embodiments, the client processing unit 550 may be configured to selectively filter out at least one frequency range of the PCD output signal 540 in which feedback is occurring. In some embodiments, the processing unit 550 may perform the function of at least one high-pass filter, at least one band-pass filter, at least one low-pass filter, at least one band-stop filter, and/or of the like.

In some embodiments, the PA system 140 may output a speaker signal 570 (such as, but not limited to, corresponding to the client output signal 560). In some embodiments, the client output signal 560 may be provided to at least one processing unit (not shown) of the PA system 140 to adjust the client output signal 560, for example, to manage feedback, adjust volume, and/or the like. The processing unit may include at least one processor (not shown) coupled to at least one memory unit (not shown). A speaker signal 570 may be provided by the PA system 140 to the at least one electronic speaker device 141. In some embodiments, in response to a detection of an insufficient output volume, the amplitude of the client output signal 560 may be increased, thus increasing the volume of the outputted sound. In some embodiments, in response to a detection of feedback, the amplitude of the client output signal 560 may be decreased, thus decreasing the volume of the outputted sound and reducing feedback.

In some embodiments, one of the audio signals 520, 540, 560, 570 may be adjusted, as described. In other embodiments, two or more of the audio signals 520, 540, 560, 570 may be adjusted. For example, a frequency adjustment may be performed on the PCD output signal 540 by the processing unit 530 of the PCD 110 and an amplitude adjustment to one or more of the signals (such as, but not limited to, the microphone signal 520, the PCD output signal 540, the client output signal 560, and/or the speaker signal 570) may be applied concurrently by one or more of the processing units 530 or 550 or the PA System 140.

Referring to FIGS. 1-6, example interactions between the components 110, 120, 130, 140 are illustrated in accordance with some embodiments. In some embodiments, an active moderator session 610 may be established between the host 120 and the client 130 to enable communication between the host 120 and the client 130. For example, adjustment requests may be transmitted from the host 120 to the client 130 during the active moderator session 610. In some embodiments, the active moderator session 610 may be established at or near the beginning of a conference or seminar (or at other suitable time), and remain active throughout the entire (or throughout one or more portions of) the conference.

In some embodiments, the active moderator session 610 may be established in response to the host 120 (or an operator of the host 120) detecting a triggering event. For example, in response to the operator perceiving feedback, the operator may operate the user interface device 350 of the host 120 to control the host 120 to establish an active moderator session 610 with the client 130. Alternatively or in addition, the active moderator session 610 may be established between the host 120 and the client 130 automatically when an active participant session 620 is established. For example, when the active participant session 620 is established between the PCD 110 and the client 130, the client 130 may automatically send a request to the host 120 to initiate an active moderator session 610. In particular embodiments, if the host 120 confirms the request, then the active moderator session 610 may be established. For example, an exchange of credentials between the PCD 110 and the client 130 may prompt a start of the active moderator session 610.

In some embodiments, the active participant session 620 between the PCD 110 and the client 130 may be established to enable communication between the PCD 110 and the client 130. The PCD 110 may transmit the audio signals to the client 130 during the active participant session 620, and the client 130 may provide the adjustment requests to the PCD 110 during the active participant session 620. The adjustment requests may be received from the host 120 or generated by the client 130. In some embodiments, the client 130 may establish the active participant session 620 with a plurality of PCDs 110. In some embodiments, the client 130 may include a plurality of clients, each of the plurality of clients may establish an active session with the host 120.

In some embodiments, the active participant session 620 may be established in response to an indication that the user wishes to access to the PA system 140. In particular embodiments, the user, through the user interface device 250 of the PCD 110, may control the PCD 110 to send a signal, message or other indication to the client 130. In some embodiments, the client 130 may, upon receiving the indication, send a confirmation to the PCD 110 to confirm that the active participant session 620 has been established. In particular embodiments, an exchange of credentials between the PCD 110 and the client 130 may be required to initiate the active participant session 620. In some embodiments, the active participant session 620 may be established in response to a signal, message or other indication from the host 120 and/or the client 130 that the PCD 110 should be granted an active participant session 620. In some embodiments, the operator of the host 120 and/or the client 130 may control the host 120 and/or the client 130 to send the indication via the user interface devices 350, 450. In other embodiments, the host 120 and the client 130 may send the indication automatically. Examples of methods and systems for establishing the active participant session 620 (and/or the active moderator session 610) include, but are not limited to, those described in U.S. patent application Ser. No. 13/275,100, filed Oct. 17, 2011 (titled SHARING PUBLIC ADDRESSING SYSTEM USING PERSONAL COMMUNICATION DEVICES IN AN AD-HOC NETWORK), which is incorporated herein by reference in its entirety.

In some embodiments, the client 130 may be operatively coupled, via a connection 630, to the PA system 140 to enable the transfer of the data between the client 130 and the PA system 140. In some embodiments, the connection 630 may be a fixed connection between the client 130 and the PA system 140. In other embodiments, the connection 630 between the client 130 and the PA system 140 may be or include a local or network wireless connection.

Various advantages can be associated with configuring the client 130 to establish communication sessions with each of the PCD 110, the host 120, and the PA system 140. For example, with such configurations, each of the host 120, the PCD 110, and the PA system 140 may only need to communicate with one other component to perform its functions in the audio signal adjustment system 100. This can help to conserve resources of the host 120, the PCD 110, and the PA system 140.

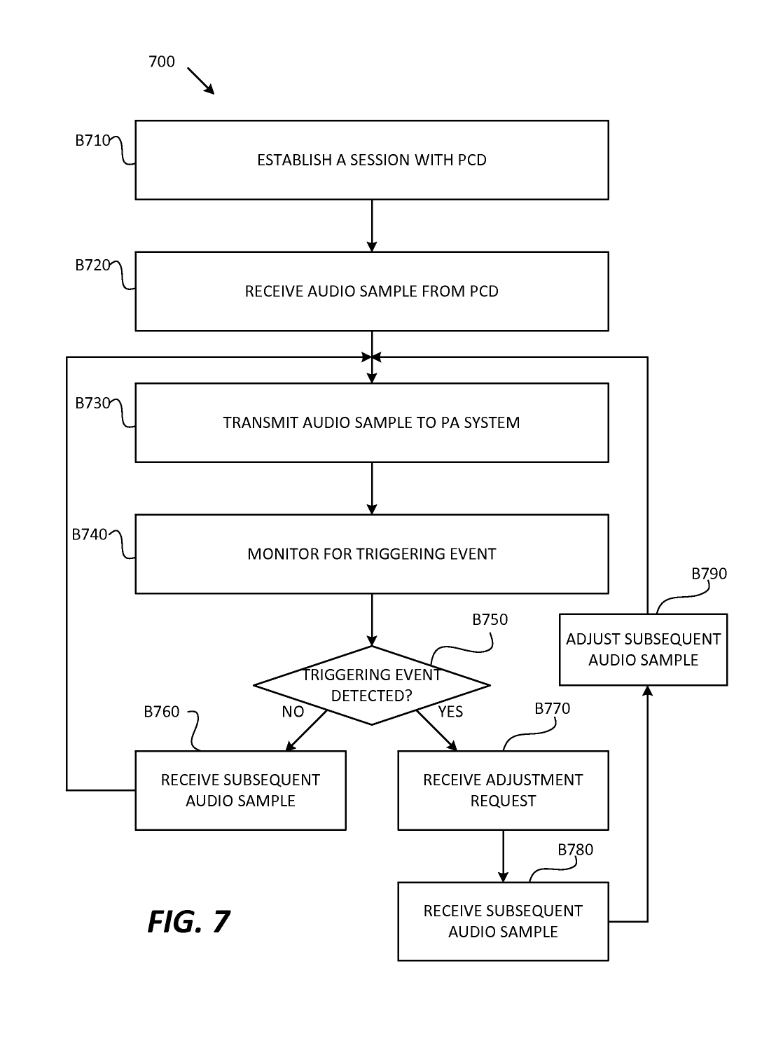

Referring to FIGS. 1-7, a process 700 for adjusting audio signal for the PA system 140 in accordance with various embodiments is illustrated. At block B710, a session between the PCD 110 and the client 130 may be established. In some embodiments, the session may be an active participant session 620 established in any suitable manner such as (but is not limited to) manners as discussed herein. The session may be established after an active moderator session 610 between the host 120 and the client 130 is established.

Next, at block B720, the client 130 may receive an audio signal (such as, but not limited to, microphone signal 520) sent by the PCD 110. In some embodiments, the audio signal may be sent after the initiation of the active participant session 620, and communication in the active participant session 620 may be provided by the network 150. The PCD 110 may first capture sound 510 with at least one microphone 210, then convert the captured sound into the audio signal (such as, but not limited to, microphone signal 520) with the at least one processor 220 and the at least one memory unit 230 for transferring to the client 130.

Next, at block B730, the client 130 may transmit the received audio signal to the PA system 140 for broadcasting. The client 130 may transmit the audio signal to the PA system 140 over the connection 630. The PA system 140 may receive the transmitted audio signal and broadcast the audio signal as outputted sound via the at least one speaker 141.

The audio signal may initially be in a predetermined state, i.e., the state that the audio signal may be transmitted or broadcasted before any adjustment takes place. In some embodiments, the predetermined state may be the natural state of the audio signal without any modifications or adjustments. In other embodiments, the predetermined state may be the state of the audio signal after preliminary modification. The preliminary modification may include adjusting at least one of the microphone signal 520, the PCD output signal 540, the client output signal 560, and the speaker signal 570, deactivating capturing sound in at least one direction of the microphone 210, filtering out at least one frequency range, and/or of the like.

In some embodiments, the preliminary modification may be set manually by the user through the user interface device 250 of the PCD 110, or the operator through the user interface devices 350, 450 of the host 120 and/or the client 130. In other embodiments, the preliminary modification may be set automatically by one or more of the components 110, 120, 130, 140. The component that sets the preliminary modifications may itself perform the preliminary modification, or it may forward a preliminary modification request to another component for modification. Preliminary modification (set manually or automatically) may be saved to at least one user profile of the PCD 110 so that the user may select to preliminarily modify the audio signals in accordance with the preferences set forth in the user profile. In addition, preliminary modifications relating to a plurality of users may be saved to separate user profiles of a same PCD 110.

In some embodiments, setting the predetermined state may include scaling at least one of the signals 520, 540, 560, 570 by at least one predetermined scaling factor. In one example, at least one predetermined scaling factor greater than 1 (such as, but not limited to, 1.2, 1.5, or 3) may be applied to increase the amplitude of the signals 520, 540, 560, 570. In another example, at least one predetermined scaling factor less than 1 but greater than 0 (such as, but not limited to, 0.3, 0.5, or 0.8) may be applied to decrease the amplitude of the signals 520, 540, 560, 570. In some embodiments, a same predetermined scaling factor may be applied to a plurality of the signals 520, 540, 560, 570. In other embodiments, two or more different predetermined scaling factors may be applied to the plurality of the signals 520, 540, 560, 570.

In some embodiments, the predetermined scaling factor may be fixed (such as, but not limited to, 0.3, 0.5, 0.8, 1.2, 1.5, or 3) such that the same predetermined scaling factor may be applied to at least one of the signals 520, 540, 560, 570 in the beginning of every session. In other embodiments, the predetermined scaling factor may be determined dynamically and automatically by at least one of the components 110, 120, 130, 140, such that a different predetermined scaling factor may be applied in the beginning of every session. In particular embodiments, the dynamic determination may be based at least in part on the speaking habit of the user of the PCD 110 and/or the environment in which the PA system 140 is deployed. With respect to the speaking habit of the user, the predetermined scaling factor may be applied to scale the audio signals 520, 540, 560, 570 if the user may have been the cause of feedback or insufficient output volume that had occurred previously. In some examples, the user may be the cause if the user speaks too loudly/softly or holds the PCD 110 too close/far. Further, the environment (such as, but not limited to, the placement of the speakers, the acoustics of the conference room in which the PA system 140 may located) may also impact audio signals such that a triggering event may occur. In some embodiments, the PCD 110 may save data related to previous usage of the PCD 110 in the memory unit 230 and select the predetermined scaling factors based on the saved data. In particular, the data may include, among others, previous predetermined scaling factors applied, scaling factors used in the adjustment process, past sessions identifiers that may identify each session to which the PCD 110 may have connected to, a mapping vector containing pointers that map the scaling factors to corresponding sessions. In some embodiments, the predetermined scaling factor may be the same as a last scaling factor or a sum of total scaling (i.e., sum of total scaling refers to multiplying all scaling factors applied in a session; for example, if two scaling factors, 0.8 and 0.5, were applied in a previous session, then the sum of total scaling is 0.8 multiplied by 0.5, which is 0.4) applied in a previous session. In another example, the predetermined scaling factor may be the average of the sum of total scaling of last ten sessions.

In some embodiments, the predetermined state may refer to the microphone 210 of the PCD 110 being initially configured to capture sound in at least one predetermined sound-capturing direction. The predetermined direction may be some or all available sound-capturing directions of the microphone 210. The PCD 110, the host 120, and/or the client 130 may automatically set the predetermined direction based at least in part on the speaking habit of the user of the PCD 110 and/or the environment in which the PCD 110 is used as a microphone. In some embodiments, the PCD 110 may save data related to previous usage of the PCD 110 in its memory unit 230 and select the predetermined direction based at least in part on the saved data. The saved data may include, among others, previous sound-capturing directions, directions eliminated in a previous session, and corresponding session identifiers that may identify each of the session to which the PCD 110 was connected to. In some embodiments, the predetermined sound-capturing direction correspond to the predetermined direction applied in a most recent session. In another example, the predetermined direction may be all available sound-capturing directions other than at least one direction that may be frequently deactivated during the adjustment process in a number of previous sessions.

In some embodiments, the predetermined state may also refer to initially configuring the PCD 110 to transmit the audio signal at a predetermined frequency range. The predetermined frequency range may be the entire available frequency spectrum or a subset of the entire frequency spectrum. The PCD 110, the host 120, and/or the client 130 may automatically set the predetermined frequency range based at least in part on the speaking habit of the user of the PCD 110 and/or the environment in which the PCD 110 is used as a microphone. For example, acoustics of the room and placement of the speakers may cause a certain frequency range to contain feedback. In some embodiments, the PCD 110 may save data related to previous usage of the PCD 110 in its memory unit 230 and select the predetermined frequency range based at least in part on the saved data. The saved data may include, among others, frequency ranges filtered out in previous sessions, previous predetermined frequency ranges, and corresponding session identifiers that may identify each of the session to which the PCD 110 was connected to. For example, in some embodiments, the predetermined frequency range may correspond to a frequency range applied in a most recent session (i.e., the frequency range after filtering out at least one frequency range in the most recent session).

Two or more of the preliminary modification schemes disclosed above regarding the predetermined state (such as, but not limited to, setting a predetermined scaling factor, predetermined sound-capturing direction, and predetermined frequency range) may be implemented in any combination. Transmitting and broadcasting the audio signal in the predetermined state as set forth above may allow the audio signal to be preliminarily modified before any further adjustment occurs. As the preliminary modification process may be based on the speaking habit and/or the environment, fewer iterations of the adjusting loop may be required to further adjust the audio signals, thus improving the efficiency of the adjustment process.

Next at block B740, a triggering event may be monitored for. A triggering event is an event that, if occurs, may require adjustment of the audio signal. In various embodiments, a triggering event may be an occurrence of feedback, insufficient output volume, and/or the like. In some embodiments, a triggering event can be monitored manually by the operator of the host 120 (i.e., the operator may listen to the sound outputted by the PA system 140 for a triggering event). In some embodiments, the operator of the host 120 may detect both types of triggering events simultaneously from a single PCD 110 (such as, but not limited to, both feedback and insufficient output volume) or two or more triggering events simultaneously from two or more PCDs 110 that are connected to the PA system 140 at the same time (such as, but not limited to, feedback for one of the PCDs 110 and insufficient output volume for the other one of the PCDs 110, or insufficient output volume for both of the PCDs 110).

Next at block B750, if a triggering event is not detected (B750:No), then no action may be taken by the host 120, given that the operator of the host 120 does not perceive that a triggering event occurred. Subsequent audio signal may be received at B760 and processed according to blocks B730-B750 (i.e., audio signal may be continuously received, broadcasted, and monitored) until a triggering event is detected. In some embodiments, if a triggering event has not been detected in a predetermined amount of time (such as, but not limited to, 100 ms, 150 ms, or 300 ms), an indication indicating that a triggering event has not occurred in that given time period may be sent automatically or manually (by the operator), through the user interface device 350 of the host 120, to the PCD 110.

On the other hand, at block B770 (B750:Yes), an adjustment request may be sent by the host 120 in response to a triggering event being detected. In some embodiments, the operator may instruct the host 120, with the user interface device 350 of the host 120, to send the adjustment request. In one example, the host 120 presses a touch screen or a button to indicate to the host 120 that feedback was detected. The host 120, in response, may send the adjustment request to the client 130 and/or the PCD 110. In some embodiments, the host 120 sends the adjustment request to the client 130. The client 130 then provides the adjustment request to the PCD 110. In some embodiments, the user interface device 350 of the host 120 may allow the operator to select the type of triggering event (such as, but not limited to, feedback or insufficient output volume), the PCD 110 (in the case that multiple PCDs 110 may be connected) that may be responsible for the triggering event, preset options for the operator to input the audio signals 520, 540, 560, 570 to be adjusted, the details of adjustment, and/or the like. In some embodiments, the display of the user interface device 350 of the host 120 may show a confirmation to the operator that the adjustment request has been sent.

Next at block B780, the PCD 110 may receive (capture) subsequent audio signal. Next at block B790, the PCD 110 and/or the client 130 may adjust the subsequent audio signal in response to the adjustment request. In various embodiments, the PCD 110, the client 130, and/or the PA system 140 may be configured to perform different actions depending on the type of the adjustment request being sent from the host 120. The adjusted subsequent audio signal may then be processed according to blocks B730-B750.

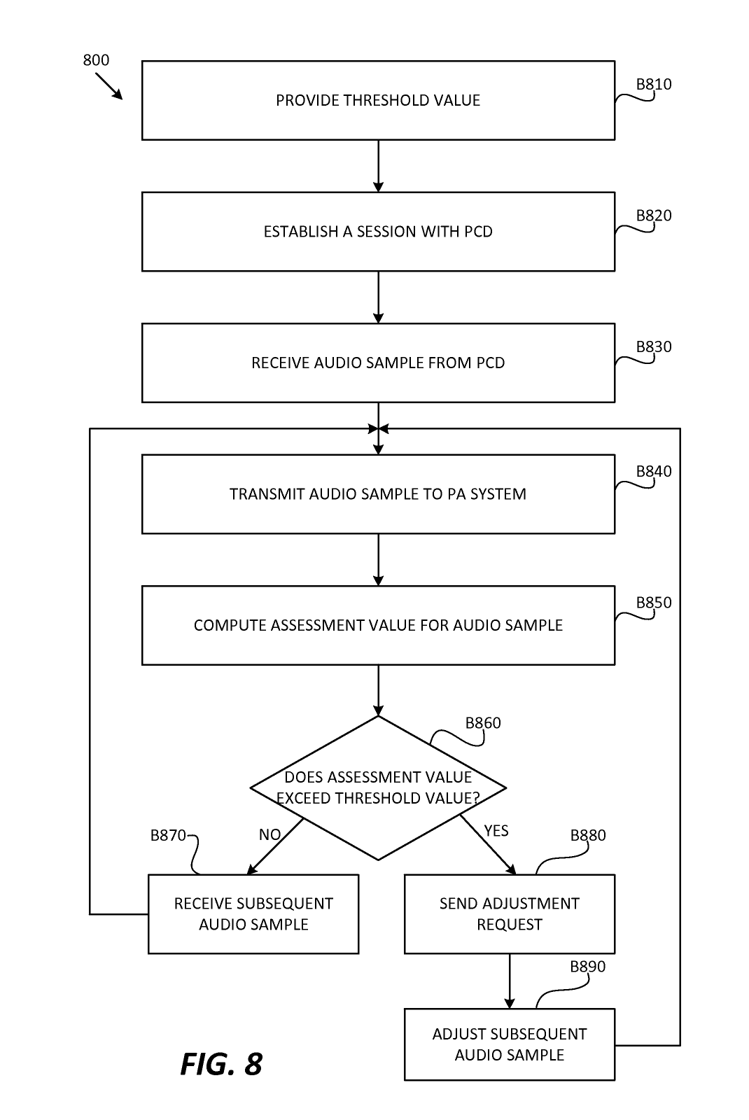

Referring to FIGS. 1-8, illustrated (by at least one of the components 110, 120, 130, 140) is an example of a process 800 through which audio signal may be adjusted automatically (by at least one of the components 110, 120, 130, 140) in accordance with various embodiments. At block B810, a threshold value may be provided to at least one of the components 110, 120, 130, 140. In some embodiments, a plurality of threshold values may be provided to the at least one components 110, 120, 130, 140. The threshold value may be a threshold signal energy content value or a threshold audio signal amplitude. In some embodiments, the threshold value may be set by at least one of the components 110, 120, 130, 140 automatically. In other embodiments, the threshold value may be set by the user via the user interface device 250 of the PCD 110, or the operator via the user interface device 350 of the host 120.

Next, at block B820, a session between the PCD 110 and the client 130 may be established. In some embodiments, the session may be an active participant session 620 that can be established in any suitable manner such as (but is not limited to) discussed in the disclosure. The session may occur after an active moderator session 610 between the host 120 and the client 130 is established.

Next, at block B830, the PCD 110 may send the audio signal to the client 130. In some embodiments, the audio signal may be sent after the initiation of the session, and communication in the session may be viable through the network 150. The PCD 110 may first capture sound 510 with at least one microphone 210, then convert the captured sound into audio signal (microphone signal 520), with the at least one processor 220 and the at least one memory unit 230, for transferring to the client 130. In some embodiments, the PCD 110 may initially transmit the audio signal in a predetermined state in any suitable manner such as (but is not limited to) discussed in the disclosure.

Next at block B840, the received audio signal may be transmitted to the PA system 140 for broadcasting. The client 130 may transmit the audio signal to the PA system 140 over the connection 630. The PA system 140 may receive the transmitted audio signal and broadcast the audio signal as outputted sound via its at least one speaker 141.

Next at block B850, at least one of the components 110, 120, 130, 140 (i.e., at least one detecting component) may analyze the outputted audio signal and compute an assessment value for the outputted audio signal. In some embodiments, the PCD 110 may, via its at least one microphone 210, capture the outputted sound and convert the outputted sound into audio signal. Then, the PCD 110 may analyze the audio signal and compute an assessment value with the at least one processor 220 and the at least one memory unit 230. In particular embodiments, the assessment value may represent the energy content of the audio signal. For example, the energy content may be calculated by computing a quadratic mean of the collected audio signal for a predetermined duration (such as, but not limited to, 10 ms, 50 ms, 100 ms, or 110 ms). Quadratic mean may be calculated as following over n samples (x₁, x₂, x₃, . . . , xₙ).

$${X}_{( mean )} = \sqrt{\frac{1}{n} ( {x}_{1}^{2} + {x}_{2}^{2} + {x}_{3}^{2} + … + {x}_{n}^{2} )}$$

At block B860, the assessment value may be compared to the threshold value. In some embodiments, one of the components 110, 120, 130, 140 (such as, but not limited to, the PCD 110 or the host 120) may forward the assessment value to another component to which the threshold value may be provided for performing the comparison. In other embodiments, the component that computed the assessment value may itself compare the assessment value with the threshold value.

Next, at block B870 (B860:NO), if the assessment value does not exceed the threshold value (signifying that a triggering event has not occurred), no adjustment may be taken by any of the components 110, 120, 130, 140. Therefore, at block B870, the subsequent audio signal may be received by the client 130 but no adjustment may occur. The subsequent audio signal may be transmitted to the PA system 140 for broadcasting at block B840, thus starting another iteration of the process 800.

On the other hand, if the threshold value is exceeded by the assessment value, then at least one of the components 110, 120, 130, 140 (i.e., at least one adjusting component) may adjust the subsequent audio signal based on a set adjustment criteria. For example, at block B880 (B860:YES), the subsequent audio signal may be received by the adjusting component, and the adjusting component may adjust the subsequent audio signal. In some embodiments, the component that automatically detects the triggering event may not be the component that performs the adjustment. For example, the automatic detection process may occur in the host 120 while the automatic adjusting process may occur in the PCD 110. Similar to what was disclosed above, an adjustment request may be sent from the detecting component to the adjusting component via the network 150, and the adjusting component may adjust the subsequent audio signal based on the adjustment request. For example, the component may adjust the amplitude of the subsequent audio signal by adjusting at least one of the audio signals 520, 540, 560, 570, the sound-capturing directions of the microphone 210, the frequency range, and/or the like. In particular embodiments, the adjustment details may be based on the difference between the assessment value and the threshold value. For example, if the assessment value exceeds the threshold value by a given amount (such as, but not limited to, if the assessment value is 150%, 300%, or 500% of the threshold value), then at least one scaling factor (such as, but not limited to, 0.6, 0.8, or 0.9) that corresponds to the amount may be applied.

In some embodiments, the detecting component may compute the assessment value for the audio signals periodically (such as, but not limited to, every 0.05, 0.1, 0.3, or 0.5 seconds). In some embodiments, every time the detecting component detects a triggering event (i.e., when the assessment value exceeds the threshold value), the detecting components may send an adjustment request locally or via a network 150 to other components. In other embodiments, the detecting component may send an adjustment request when it detects a triggering event, and may send a confirmation indication when the triggering event has subsided.

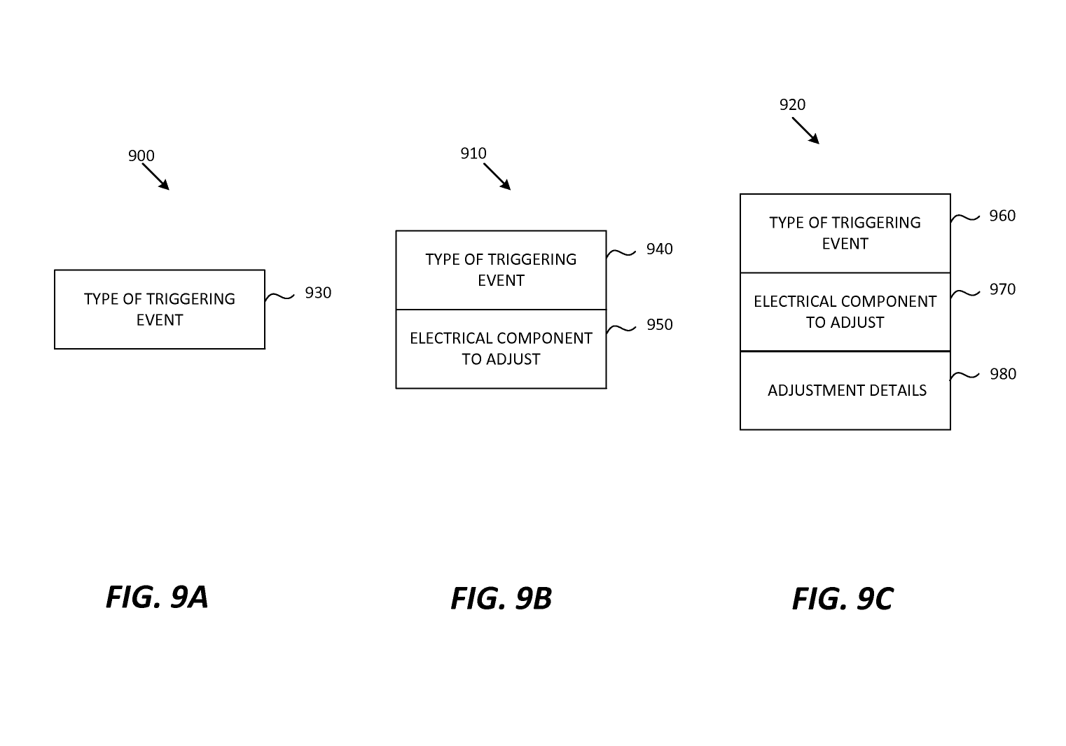

FIGS. 9A-9C represent embodiments of adjustment requests 900, 910, 920. Referring to FIGS. 1-8 and 9A, an example of the adjustment request 900 is illustrated in accordance with some embodiments. The adjustment request 900 may include a message 930 that may indicate the type of triggering event that may be detected. In embodiments where the system may be configured to monitor and adjust for one type of triggering event (such as, but not limited to, feedback or insufficient output volume, but not both), the adjustment request 900 may only include a message that indicates a triggering event has occurred.

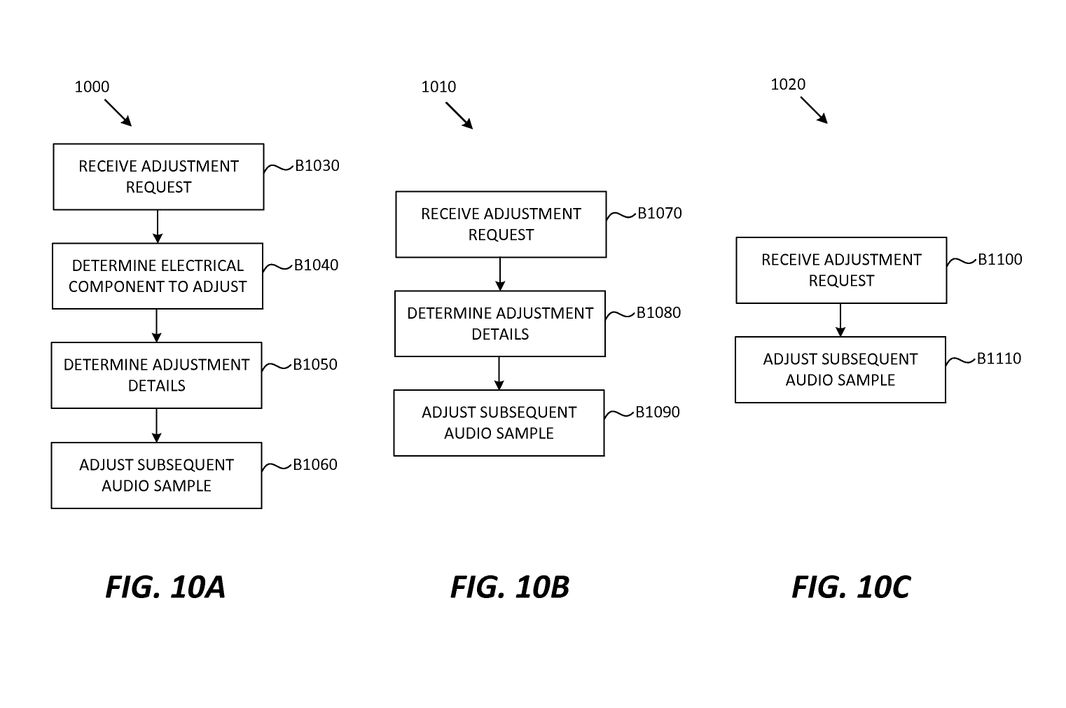

The PCD 110, upon receiving the adjustment request 900 from the host 120 or the client 130, adjusts the subsequent audio signal according to a set of criteria. Referring to FIGS. 1-8, 9A, and 10A, illustrated is an process 1000 for adjusting the subsequent audio signal once the adjustment request 900 is received. At B1030, the adjustment request 900 having a message 930 that indicates the type of triggering event may be received by the PCD 110. Next at B1040, the PCD 110 adjusts the microphone signal 520 in response to the request. For example, if the triggering event is a feedback, then the PCD 110 may reduce the amplitude of the subsequent audio signal, filter out frequency ranges, deactivate sound-capturing directions of the microphone 210, and/or the like. In some embodiments, if the triggering event is insufficient output volume, then the PCD 110 may increase the amplitude of the subsequent audio signal. In other embodiments, the adjustment request may be sent to the client 130 for adjusting the PCD output signal 540 in response to the request, and/or to the PA system 140 for adjusting the client output signal 560 and/or the speaker signal 570.

Next at B1050, the PCD 110 may select adjustment details (such as, but not limited to, the amount and manner of adjustment with respect to the microphone audio signal 520 being adjusted). In some embodiments, the PCD 110 may select to scale the amplitude of the subsequent microphone audio signal by a fixed factor (such as, but not limited to, 0.2, 0.5, 0.7, 1.2, 1.5, or 3). In some embodiments, the PCD 110 may select at least one sound-capturing direction of the microphone 210 to be deactivated. In some embodiments, the PCD 110 may select at least one frequency range to be filtered out. Next at B1060, the PCD 110 may adjust the subsequent microphone audio signal according to the selection made by the PCD 110.

Referring to FIGS. 1-8, and 9B, the adjustment request 910 may include a message 940 that indicates the type of triggering event detected and a command 950 to adjust at least one of the audio signals 520, 540, 560, 570. For example, the command 950 may be a command to adjust the amplitude of the microphone signal 520 and the PCD output signal 540. In some embodiments, the command 950 may be set by the operator manually via the user interface device 350 of the host 120. In other embodiments, the command 950 may be set by the host 120 automatically according to any suitable criteria including, but are not limited to, processing time and power consumption.

Referring to FIGS. 1-8, 9B, and 10B, at B1070, the adjustment request 910 having the message 940 and the command 950 may be received by the PCD 110, the client 130, and/or the PA system 140. Next at B1080, the adjustment details is determined with respect to the at least one of the audio signals 520, 540, 560, 570 specified by the command 950 of the adjustment request 910. Lastly at B1090, the PCD 110, the client 13, and/or the PA system 140 may adjust the subsequent audio signal according to the adjustment details determined.

In some embodiments, the PCD 110, the client 130, and/or the PA system may adjust the at least one of the audio signals 520, 540, 560, 570 by a fixed factor for every adjustment request 900, 910 received. For example, in response to the PCD 110 receiving any adjustment request 900, 910 indicating that feedback is the triggering event, the PCD 110 may reduce the microphone signal 520 by a fixed factor (such as, but not limited to, 0.05, 0.1, or 0.2).

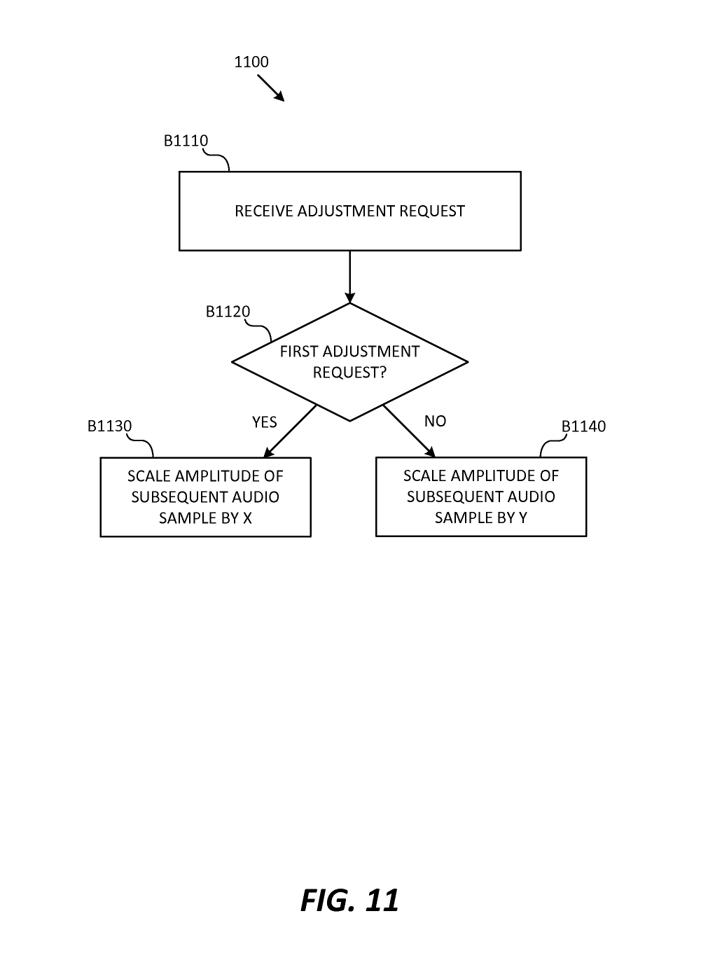

In some embodiments, the PCD 110, the client 130, and/or the PA system may be configured to respond to the adjustment request 900, 910 with a set of predetermined responses when two or more adjustment requests 900, 910 may be received. In particular embodiments, a different scaling factor may be applied in response to each adjustment request 900, 910 in a sequence of adjustment requests. Referring to FIGS. 1-8 and 9-11, illustrated is an example of a process 1100 in which the PCD 110, the client 130, and/or the PA system 140 may be configured to respond to two or more adjustment requests 900, 910. At B1110, the PCD 110 and/or the client 130 may receive an adjustment request 900, 910 containing either only the type of triggering event 930 or the type of triggering event 940 and the audio signals 520, 540, 560, 570 to be adjusted 950. At B1120, a determination may be made as to whether the adjustment request 900, 910 received may be a first adjustment request received. In some embodiments, the first adjustment request may be the first adjustment request received in the current session. In other embodiments, the first adjustment request may be the first adjustment request received in a predetermined period of time (such as, but not limited to, 30 seconds, 2 minutes, 10 minutes, or an hour) since a last adjustment request was received. If the adjustment request 900, 910 received is the first adjustment request, then at B1130 (B1120:YES), the at least one of the audio signals 520, 540, 560, 570 may be scaled by a first factor, denoted by X. If the adjustment request 900, 910 received is not the first adjustment request, then at B1140 (B1120:NO), the at least one of the audio signals 520, 540, 560, 570 may be scaled by a second factor, denoted by Y. In some embodiments, X and Y may be different, such that X may be greater than Y, or Y may be greater than X. For example, amplitude of the PCD output signal 540 may be reduced by a first factor (such as, but not limited to, 0.3) in response to a first adjustment request, and reduced by a lesser factor (such as, but not limited to, 0.05) for every subsequent adjustment request 1200 (such as, but not limited to, the second adjustment request, the third adjustment request, the fourth adjustment request, etc.) received. In addition, Y, which denotes the scaling factor of any subsequent adjustment in response to the subsequent adjustment requests, may also be different depending on an order in which the adjustment requests 900, 910 may be received. In some embodiments, the PCD 110 may increase the amplitude of the at least one audio signals 520, 540, 560, 570 to compensate for over-reduction of the amplitude, vice versa.

In some embodiments, the PCD 110, the client 130, and/or the PA system 140 may begin to scale the audio signals 520, 540, 560, 570 by a fixed factor periodically (such as, but not limited to, every 0.05, 0.1, or 0.3 second) in response to the first adjustment request, until no adjustment request 900, 910 has been received by the PCD 110 for a predetermined period of time (such as, but not limited to, 0.3, 0.5, or 1 second). In some embodiments, the PCD 110, the client 130, and/or the PA system 140 may begin to scale the audio signals 520, 540, 560, 570 by a fixed amount periodically (such as, but not limited to, every 0.05, 0.1, or 0.3 second) in response to the first adjustment request, until a message indicating that the feedback or the insufficient output volume has been eliminated is received by the PCD 110 and/or the client 130. The message may be sent by the host 120 automatically when the operator has not indicated that a triggering event has occurred for a predetermined time period (i.e., 0.2, 0.5, 1, or 2 seconds) since the last indication.

Referring to FIGS. 1-8 and 9C, the adjustment request 920 may include a message 960 that indicates the type of triggering event that may be detected, a command 970 to adjust at least one of the audio signals 520, 540, 560, 570, and adjustment details 980 that specify how each of the selected audio signals 520, 540, 560, 570 may be adjusted. In some embodiments, the adjustment details can be set by the operator manually via the user interface device 350 of the host 120 or by the PCD 110, the host 120, and/or the client 130 automatically according to any suitable criteria, including but are not limited to, processing time and efficiency.

Referring to FIGS. 1-8, 9C, and 10C, at block B1100, an adjustment request 920 having the message 960, the command 970, and the adjustment details 980 may be received by at least one of the PCD 110, the client 130, and/or the PA system 140. At B1110, the PCD 110 may adjust the subsequent audio signal according to the adjustment details 980. The adjustment details may include, but are not limited to, scaling the amplitude of at least one of the audio signals 520, 540, 560, 570, eliminating at least one sound-capturing direction of the microphone, and filtering out at least one frequency range.

Now referring to FIGS. 1-11, processes described in this disclosure may require a short period of time (such as, but not limited to, around 90-150 milliseconds, or approximately 110 milliseconds) to complete one iteration via the audio signal adjustment path (i.e., through B750, B770, B780, and B790).

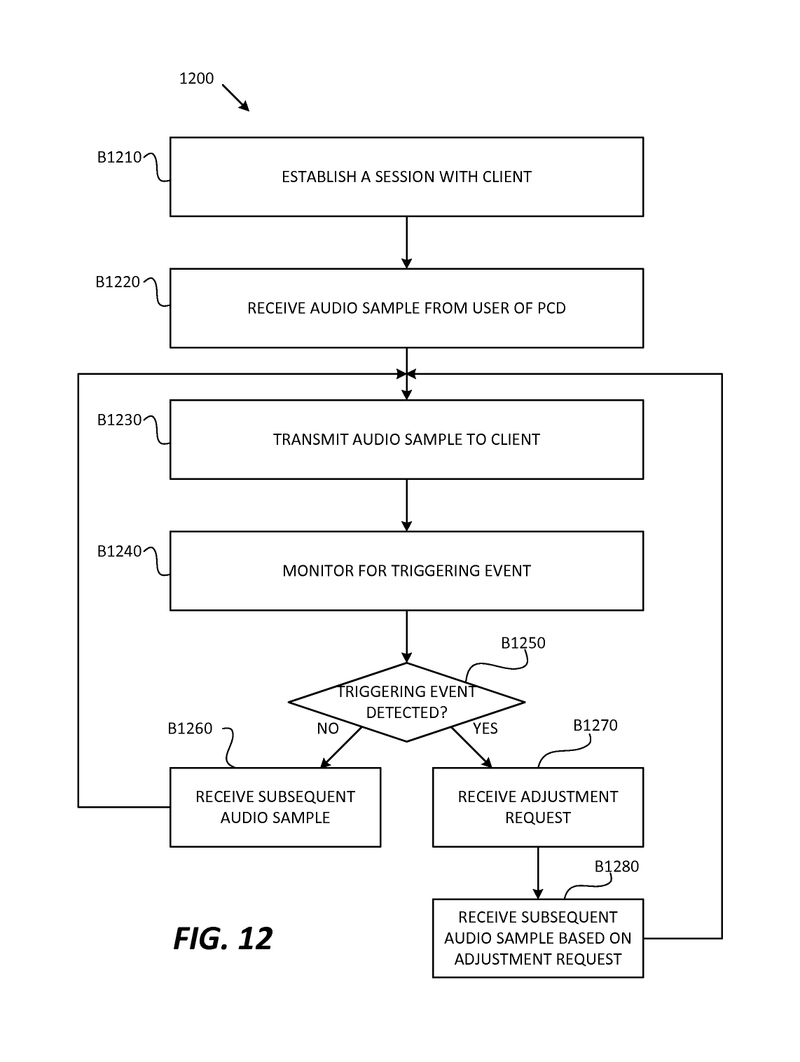

Referring to FIGS. 1-12, illustrated is a process 1200 performed by the PCD 110 for adjusting audio signal for the PA system 140 in accordance with various embodiments. At block B1210, the PCD 110 may establish a session with a client 130 in any suitable manner such as (but is not limited to) discussed in the disclosure. Next at block B1220, the PCD may receive audio signal from the user as the user speaks into the microphone 210 of the PCD 110. Next at block B1230, the PCD 110 may transmit the audio signal received from the user to the client 130 at a predetermined state in any suitable manner such as (but is not limited to) discussed in the disclosure. In some embodiments, the client 130 may transmit the audio signal to the PA system 140 for broadcasting via at least one speaker 141 of the PA system 140. Next at block B1240, a triggering event may be monitored automatically or manually (by the operator of the host 120). Next at block B1260, if a triggering event is not detected (B1250:No), then no action is taken by the host 120, and subsequent audio signal may be received at B1260 and processed according to blocks B1230-B1250. On the other hand, at block B1270 (B1250:Yes), an adjustment request may be received by the PCD 110 in response to a triggering event being detected. Next at block B1280, the PCD 110 may receive subsequent audio signal based on the adjustment request via the microphone 210. In some embodiments, the subsequent audio signal may be adjusted by the PCD 110, the client 120, and/or the PA system 140. For example, the microphone 210 of the PCD 110 may be configured to scale the amplitude of the microphone signal 520 or deactivate at least one sound-capturing direction of the microphone 210 used to capture the subsequent audio signal. In addition, the subsequent audio signal may be adjusted based on the adjustment request in any suitable manner such as (but is not limited to) discussed in the disclosure. The adjusted subsequent audio signal then may be processed according to blocks B1230-B1250.

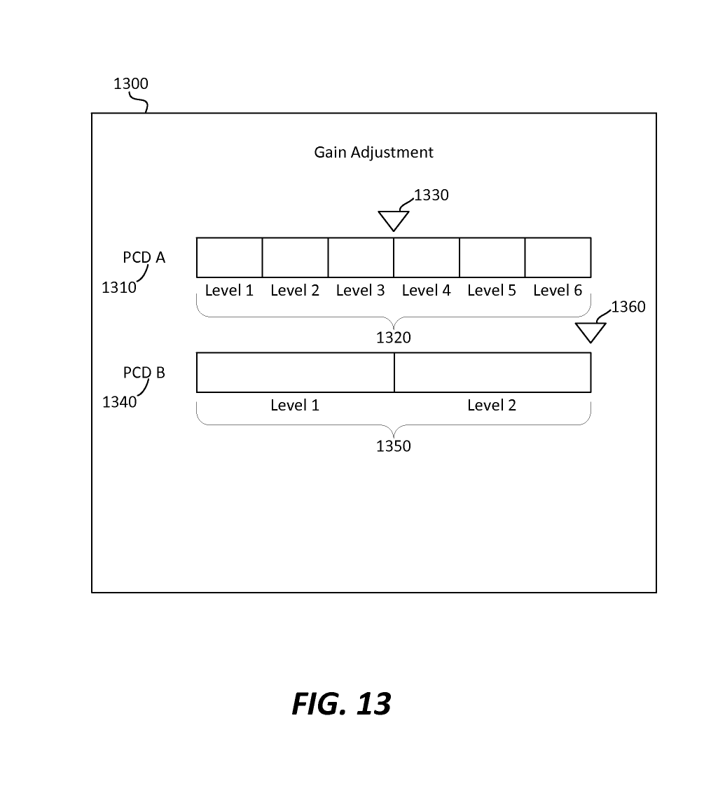

FIG. 13 illustrates an example of a gain adjustment user interface 1300 according to various embodiments. Now referring to FIGS. 1-13, the gain adjustment user interface 1300 may be a user interface (such as, but not limited to, a display screen) displayable by the PCD 110 (such as, but not limited to, through the user interface device 250), the host 120 (such as, but not limited to, through the user interface 350), and/or the client 130 (such as, but not limited to, through the user interface 450). An operator or user of the PCD 110, the host 120, and/or the client 130 may adjust the gains of the audio signals via the gain adjustment user interface 1300. In some embodiments, the host 120 and/or the client 130 may send adjustment requests to the PCD 110 to adjust the microphone gain at the microphone signal 520 and/or the output gain at the PCD output signal 540 in response to the adjustments received from the operator via the gain adjustment user interface 130.

In some embodiments, the gain adjustment user interface 1300 may include at least one PCD 110 (such as, but not limited to, PCD A 1310, PCD B 1340, and/or the like), the gains of which are to be adjusted via the gain adjustment user interface 1300. The gain adjustment user interface 1300 may include user interactive elements (such as, but not limited to, buttons, touch area, and/or the like) to adjust gains of the corresponding PCD 110 based on user interaction with the user interactive elements. For example, the gains (such as, but not limited to, the microphone gain, the output gain, and/or the like) of the PCD 110 being adjusted may be divided into discrete levels (such as, but not limited to, the first set of levels 1320 corresponding to PCD A 1310 and the second set of levels 1350 corresponding to PCD B 1340). In some embodiments, the level sets for adjusting the gains may be finer (such as, but not limited to, the first set of levels 1320 may include 6 levels, each corresponding to a separate gain adjustment value). In other embodiments, the level sets may be coarser (such as, but not limited to, the second set of levels 1350 may include 2 levels, each corresponding to a separate gain adjustment value). The gain adjustment user interface 1300 may include gain indicators (such as, but not limited to, the first gain indicator A 1330 for the PCD A 1310 and the second gain indicator B 1360 for PCD B 1340) that indicate the current gain level selected for the corresponding PCD 110. In some embodiments, a common control-set may be used for one or more PCDs (such as, but not limited to, the PCD 110).

In other or further embodiments, the PCD 110 may adjust its own microphone gain at the microphone signal 520, the output gain at the PCD output signal 540, sound capturing direction, and/or the like via an interface provided by the user interface device 250. Such interface may include user interactive elements such that when selected by the user of the PCD 110, may trigger the PCD 110 to adjust the gains or the sound capturing directions in the manner described.

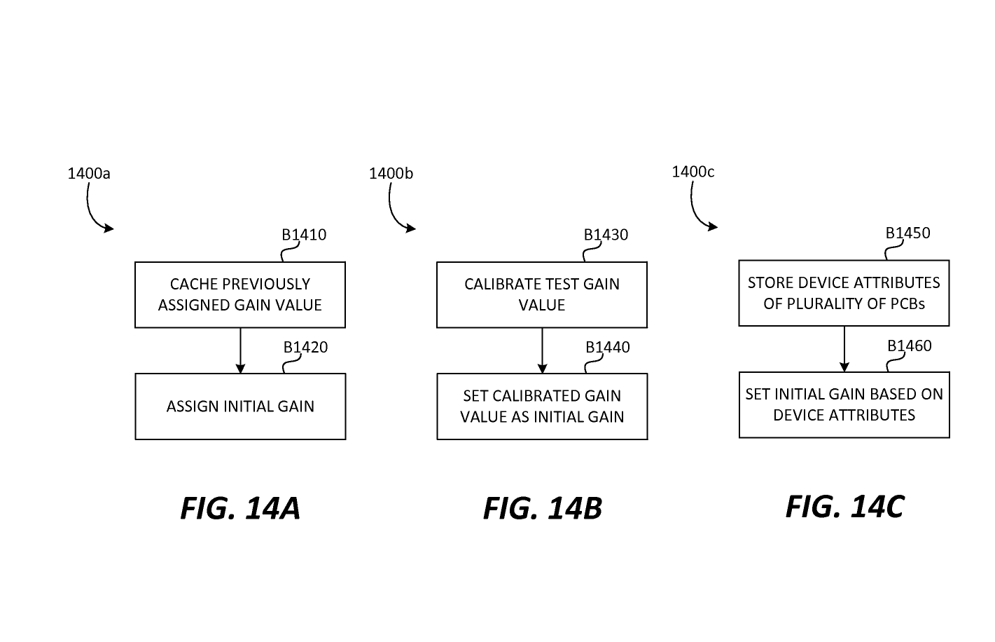

FIG. 14A is a process flow chart illustrating a first example of initial gain assignment method 1400a according to various embodiments. Now referring to FIGS. 1-14A, the PCD 110 may cache (such as, but not limited to, in the memory unit 230 or other suitable memory unit) at least one gain value previously assigned by the host 120 and/or the client 130 (such as, but not limited to, as set forth in adjustment request as described herein) at block B1410. In other embodiments, the PCD 110 may store the gain value determined by the PCD 110 itself. The at least one gain value previously assigned may be from a previous session. Next at block B1420, the PCD 110 may set the cached previously assigned gain as an initial gain for the current session. In some embodiments, only the immediate previously assigned gain is cached, in which case, the immediate previously assigned gain is set as the initial gain. In other embodiments, two or more previously assigned gain values may be cached at block B1410, where the initial gain is set as the average of the two or more previously stored gain values. In various embodiment, the PCD 110 may map location information associated with the assigned gain. Subsequently (such as, but not limited to, during next use), the PCD 110 may set the assigned gain based on the mapped location information. For example, the PCD 110 may only use a stored assigned gain if that stored assigned gain is associated with a same location based on the location information.

FIG. 14B is a process flow chart illustrating a second example of initial gain assignment method 1400b according to various embodiments. Now referring to FIGS. 1-14B, the PCD 110 may calibrate a test gain value at block B1430 before the session where an initial gain value is required. In particular, the PCD 110 may transmit test audio signals to the client 130 for playing at the PA system 140 and receive adjustment requests containing gain adjustments as the test gain values from the host 120 and/or the client 130 and/or the user of the PCD 110. Next at block B1440, the PCD 110 may set the calibrated gain value as the initial gain.

FIG. 14C is a process flow chart illustrating a third example of initial gain assignment method 1400c according to various embodiments. Now referring to FIGS. 1-14C, the host 120 and/or the client 130 may store device attributes of a plurality of PCDs (such as, but not limited to the PCD 110) at the memory unit 330 and/or the memory unit 430, respectively, at block B1450. The device attributes include the maker, model, location of the PCDs from the PA system 140 and/or the speaker 141, gain adjustments associated with each of the plurality of PCDs. Next at block B1460, a current PCD of interest (such as, but not limited to, the PCD 110) may set its own initial gain based on the device attributes associated with the plurality of PCDs. In particular embodiments, the current PCD of interest may match its own maker and model with at least one of the plurality of PCDs having the same (or substantially similar) maker and model by sending a request containing its own maker and model, location to the host 120 and/or the client 130 and receiving a response containing an initial gain based on the maker and the model, location of the current PCD of interest. The initial gain as an average gain of the gain adjustment values of the at least one of the plurality of PCDs having the same (or substantially similar) maker and model, as determined by the host 120 and/or client 130 based on and in response to the request transmitted by the current PCD of interest. As such, a heuristic gain adjustment scheme serves to improve user experience.

In some embodiments, the client 130 (or the host 120) may execute automatic gain control with respect to a PCD 110 being currently assigned the floor (such as, but not limited to, an active participant session 620 exists between the PCD 110 and the client 130). In some embodiments, the client 130 (or the host 120) may store previous gain values (such as, but not limited to, as included gain adjustment requests or otherwise) determined for previous PCDs (such as, but not limited to, the PCD 110) in the memory unit 430 (or the memory unit 330 of the host 120). The previous PCDs may have had or still have the floor (i.e., the previous PCDs may have in active participant sessions 620 with the client 130). The client 130 (or the host 120) may determine the gain adjustment values for the PCD 110 being assigned the floor based on the gain values for the previous PCDs which were assigned the floor previously. In some embodiments, the gain adjustment values for the PCD 110 currently assigned the floor may be an average of the previous gain values for the previous PCDs. This allows the client 130 (or the host 120) to adjust the gain of the PCD 110 currently assigned the floor to be at or approximate to the average gain adjustment values of the previously assigned PCDs to prevent sudden rise or drop in gain as outputted by the PA system 140.

In some embodiments, the host 120 and/or the client 130 may transmit a request over the network 150 to the PCD 110. The request may be a request to change an output frequency of the PCD output signal 540 and/or the client output signal 560. In some embodiments, the host 120 and/or the client 130 may request the PCD 110 to change its PCD output signal 540 and/or the client output signal 560 periodically (such as, but not limited to, 5 ms, 10 ms, 20 ms, and/or the like). Given that howling occurs at a same frequency over time, howling may be suppressed when the frequency of the PCD output signal 540 and/or the client output signal 560 is switched periodically to avoid amplitude building up at any one particular frequency. In some embodiments, the output frequency of the PCD output signal 540 and/or the client output signal 560 may be alternated between odd or even frequencies. In some embodiments, a predetermined set of at least two output frequencies (randomized or predetermined) may be cycled over time as the output frequency of the PCD output signal 540 and/or the client output signal 560. In some embodiments, the frequency of the PCD output signal 540 and/or the client output signal 560 may be offset by a randomized or predetermined frequency range.

In some embodiments, automatic close loop control may be implemented with respect to the client 130 to provide feedback on gain adjustment and normalize the gain across multiple PCDs (such as the PCD 110). The PCDs may use automatic gain control (AGC) or dynamic range compression (DRC) algorithms to adjust the gain based on the capabilities of the PCDs. In some embodiments, the client 130 may automatically send the adjustment request to the one of the multiple PCDs to reduce the gain (or adjust the directionality of the sound capturing direction) when the energy of the PCD output signal 540 and/or the client output signal 560 of the one of the multiple PCDs exceeds a predetermined threshold. As such, the client 130 may regulate the gain of the multiple PCDs automatically without input from the host 120. Also, the client 130 and/or host 120 may choose DRC, AGC, or some other suitable algorithm used by the PCDs based on the common capabilities (software version, algorithm support, etc) across multiple PCDs and provide that information along with the gain adjustment feedback.

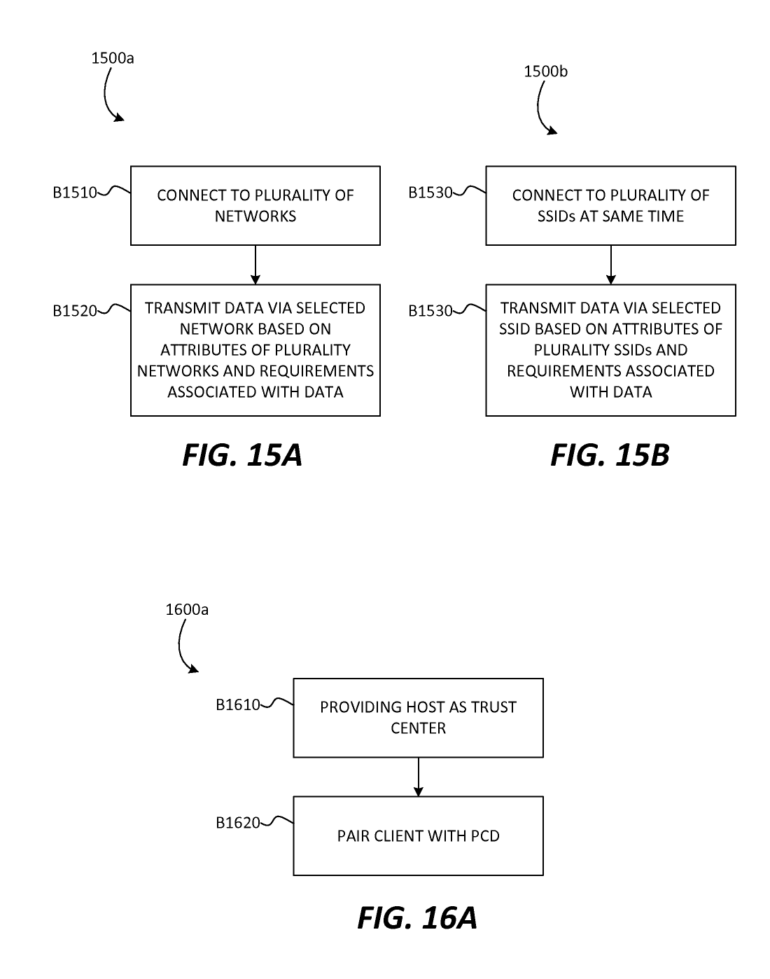

FIG. 15A is a process flowchart illustrating an example of a generalized connectivity selection method 1500a according to various embodiments. Referring to FIG. 1-15A, first at block B1510, the PCD 110 may be connected to a plurality of networks (or subnetworks/channels) at the same time for sending traffic. For example, the PCD 110 may be connected to two or more of WiFi, cellular (3G/4G/5g), BLE, Wifi-D, LTE-D, and the like at the same time. Next at block B 1520, the PCD 110 may transmit data (such as, but not limited to, audio data, metadata, and/or the like) via a selected network of the plurality of networks (or sub-networks/channels) based on attributes associated with each of the plurality of networks and requirements associated with the data.

Each network may be associated with attributes such as, but not limited to, bandwidth, quality of service (QOS), delay characteristics, load on the network, and/or the like. The data may be associated with requirements such as delay sensitivity, priority, QOS requirement, and/or the like. For example, audio data (such as, but not limited to, the PCD output signal 540) may be associated with high delay sensitivity, high priority, and/or high quality of service. For example, the application data containing the PCD output signal 540 may be transmitted over a network having high bandwidth, low delay, and/or the like. Other application data may be transmitted over another network having relatively lower bandwidth, higher delay, and/or the like. In some embodiments, whereas a PCD 110 could not located a suitable/available network to transmit a data type, such data of the data type may not be send until a suitable/available network has been discovered or made available by/to the PCD 110.

FIG. 15B is a process flowchart illustrating an example of a SSID-based connectivity selection method 1500b according to various embodiments. The SSID-based connectivity selection method 1500b may be a particular implementation of the connectivity selection 1500a (i.e., block B1530 may be a particular implementation of block B1510, and block B1540 may be a particular implementation of block B1520). Referring to FIG. 1-15B, first at block B1530, the PCD 110 may be connected to a plurality of service set identifiers (SSIDs) at the same time for sending traffic via the network 150, which may be a WiFi network associated with the multiple SSIDs. Next at block B1540, the PCD 110 may transmit data (such as, but not limited to, audio data, metadata, and/or the like) via a selected SSID of the plurality of SSIDs based on attributes associated with each of the plurality of SSIDs and requirements associated with the data.

Each SSID may be associated with attributes such as, but not limited to, bandwidth, quality of service (QOS), delay characteristics, load on the network, and/or the like. The data may be associated with requirements such as delay sensitivity, priority, QOS requirement, and/or the like. For example, audio data (such as, but not limited to, the PCD output signal 540) may be associated with high delay sensitivity, high priority, and/or high quality of service. For example, the application data containing the PCD output signal 540 may be transmitted over a SSID having high bandwidth, low delay, and/or the like. Other application data may be transmitted over another SSID having relatively lower bandwidth, higher delay, and/or the like. In some embodiments, whereas a PCD 110 could not located a suitable/available SSID to transmit a data type, such data of the data type may not be send until a suitable/available SSID has been discovered or made available by/to the PCD 110.

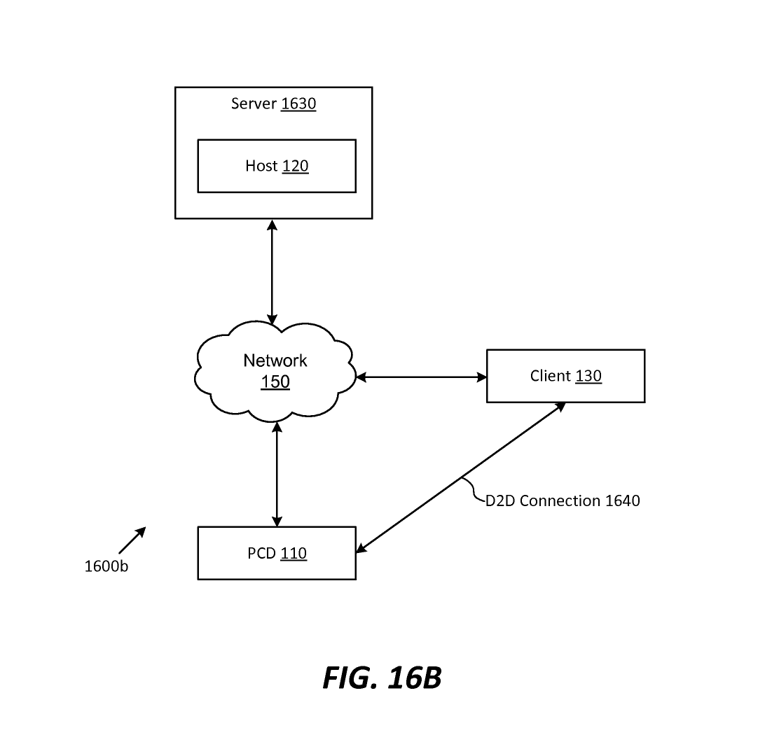

FIG. 16A is a process flowchart illustrating an example of a device-to-device (D2D) link establishing method 1600a according to some embodiments. Referring to FIGS. 1-16, in some cases, as the PCD 110 (or a plurality of PCDs), the host 120, the client 130, and/or the like communicate with each other via the network 150, a backhaul delay may appear as the data is transmitted from one device to a server supporting the network 150, and then to the receiving device. To avoid such backhaul delay, the devices are in communication via suitable device-to-device (D2D) single hop link such as, but not limited to, Wifi-Direct, BTLE, LTE-D, Bluetooth, and/or the like.

In some case, signaling for any session setup which require interaction between the PCD 110 and the host 120. The host 120 may not be in the D2D range or may not support D2D (typically servers are connected over Ethernet); data sent to or received by the host 120 may be transmitted via the network 150. The delay sensitive traffic like voice/audio data can be transmitted over D2D. One of ordinary skill in the art should appreciate that, data transfer is not limited to audio data, but also may include text messages, file sharing, streaming, and/or the like. Data may be transmitted over D2D to take advantage of the benefits the single hop link provides.

At block B1610, the host 120 (and/or the server) may be provide as a trust center for paring the client 130 with at least one PCD 110. In particular embodiments, the host 120 may store identification information (such as, but not limited to, IP address) associated with the client 130 and at least one PCD 110 store in the memory unit 330 of the host 120. Next at block B1620, the host 120 may pair the client 130 with the at least one PCD 110, for example, based on the identification information. Any suitable handshake may take place between the paired devices. In response to a successful handshake, the client 130 and the at least one PCD 110 may initiate suitable D2D communication as described.

FIG. 16B is a system diagram illustrating an example of a D2D link system 1600b according to various embodiments. The D2D link system 1600b may be correspond to the device-to-device (D2D) link establishing method 1600a. Referring to FIGS. 1-16B, the PCD 110, the server 1630 (and the host 120), and the client 130 may all be connected to each other via the network 150. The host 120 may be coupled to (via the network 150 or other suitable networks) or is a part of the server 1630. In some embodiments, the server 1630 may be provided as the trust center in the manner described when the host 120 is not a part of the server 120 or does not perform the D2D link establishment processes described herein.

The PCD 110 may send a request in the form of a signal to the server 1630 (and/or the host 120). The server 1630 (and/or the host 120) may, in response to the request, may transmit the client identification information stored as set forth in block B1610 to the PCD 110. The PCD 110 and the client 130 may then, based on the client identification information, initiate handshakes for establishing the D2D communication.

In further or other embodiments, the client may be coupled to (via the network 150 or other suitable networks) or is a part of the server 1630. It should appreciated by one of ordinary skill in the art that in addition to of establishing a D2D connection between a PCD 110 and the client 130, the PCDs amongst themselves may also establish D2D connection via the trust center of the host 120 or the server 1630.

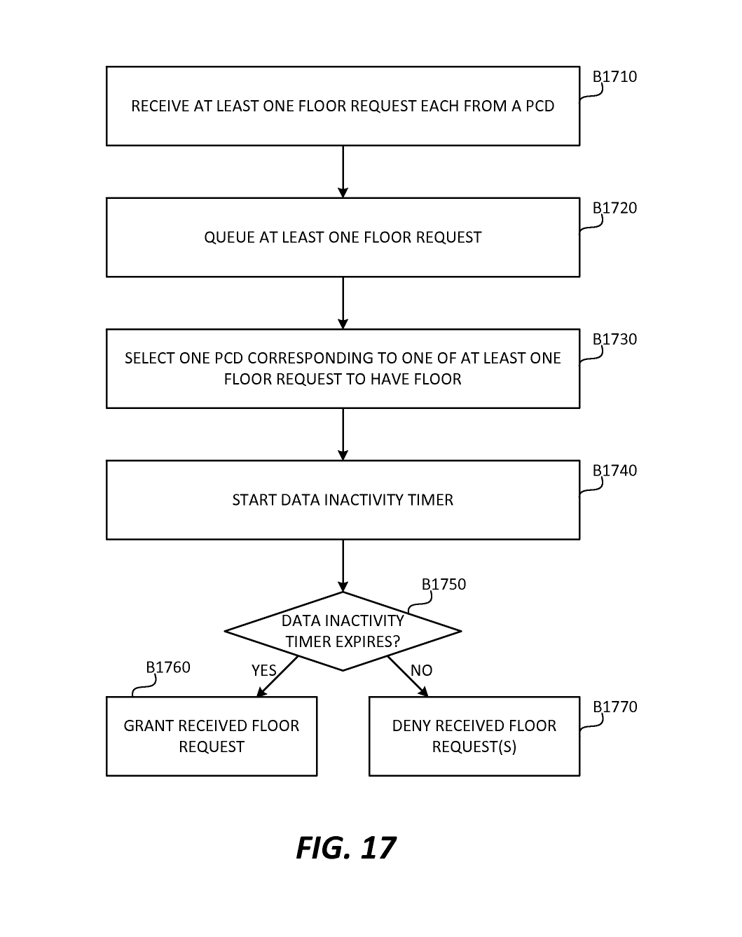

FIG. 17 is a process flowchart illustrating an example of a floor control method 1700 according to various embodiments. Referring to FIGS. 1-17, at block B1710, the client 130 may receive at least one floor request. Each floor request is received from a PCD 110. The floor request may include identification information such as, but not limited to, an IP address of the PCD 110.

Next at block B1720, the client 130 may queue the at least one floor request (such as, but not limited to, when the client 130 receives two or more floor requests from two separate PCDs 110). In some embodiments, the queue may be ordered in suitable manner such as, but not limited to, time at which the floor requests are received by the client 130 and/or other designated priority scheme. Each PCD 110 associated with the at least one floor request may be assigned a position (such as, but not limited to, a number) in the queue based on the order. The position may be transmitted back to the corresponding PCD 110 to be displayed via the user interface device 250. As such, the user of the PCD 110 may be aware of his or her position in the queue.

Next at block B1730, the client 130 may select one PCD corresponding to one of the at least one floor request to have the floor (to receive (real-time transport protocol) RTP traffic). In some embodiments, the client 130 may automatically select a PCD which transmitted a floor request that is received prior in time as compared to other floor request(s) within the queue. In other embodiments, the client 130 may select a PCD (identified with a particular identifier, such as the IP address) based on manual selection (via user interface device 450) by an operator of the client 130. After selecting the PCD, the client 130 may notify (via signaling) the selected PCD that the selected PCD has been granted the floor.

Next at block B1740, the client 130 may start a data inactivity timer counting down a predetermined time interval (such as, but not limited to, 4 seconds, 5 seconds, 10 seconds, or the like). In some embodiments, the data inactivity timer may be started as soon as the PCD has been selected. In other embodiments, the data inactivity timer may be selected when (triggered by) the energy and/or amplitude of the output PCD signal 540 falls below a predetermined threshold. The time left on the data inactivity timer may increase (to at most the full predetermined interval) or freeze to be the same when the energy associated with the audio data is above a predetermined threshold, and allowed to decrease if otherwise. At block B1750, the client 130 determines whether the data inactivity timer has expired. When the data inactivity timer has not yet expired, the client 130 may deny any received floor request(s) from at least one other PCD and does not receive any RTP data from the other PCD at block B1770 (B1750:NO). The received floor request(s) may be already been placed in the queue or has been received since the start of the data inactivity timer. On the other hand, when the data inactivity timer has expired, the client 130 may grant a received floor request at block B1760 (B1750:YES). In some embodiments, the first floor request received subsequent to the expiration of the data inactivity timer may be selected to have the floor. In other embodiments, the client 130 may select another PCD corresponding to another one of the at least one floor request in the queue, based on priority as described.

In some embodiments, a server (such as, but not limited to, the server 1630) may be connected to the network 150 for storing data (such as, but not limited to, audio data in transit, metadata, and/or the like). The host 120 and/or the client 130 may be devices that is connected to the server (such as, but not limited to, via the network 150 or other suitable network). The host 120 and/or the client 130 may access data stored on the server. In some embodiments, the server may be configured to handle the floor request (such as, but not limited to, instead of the client 130 as set forth in the floor control method 1700). Alternatively, the client 130 may be configured to control the floor. That is, the client 130 may include features of the host 120 that are used to control the floor. Having the client 130 to control the floor may be beneficial for the P2P-based PA system 140 as described herein, where there is no central entity (e.g., the host 120 or the server) for signal control

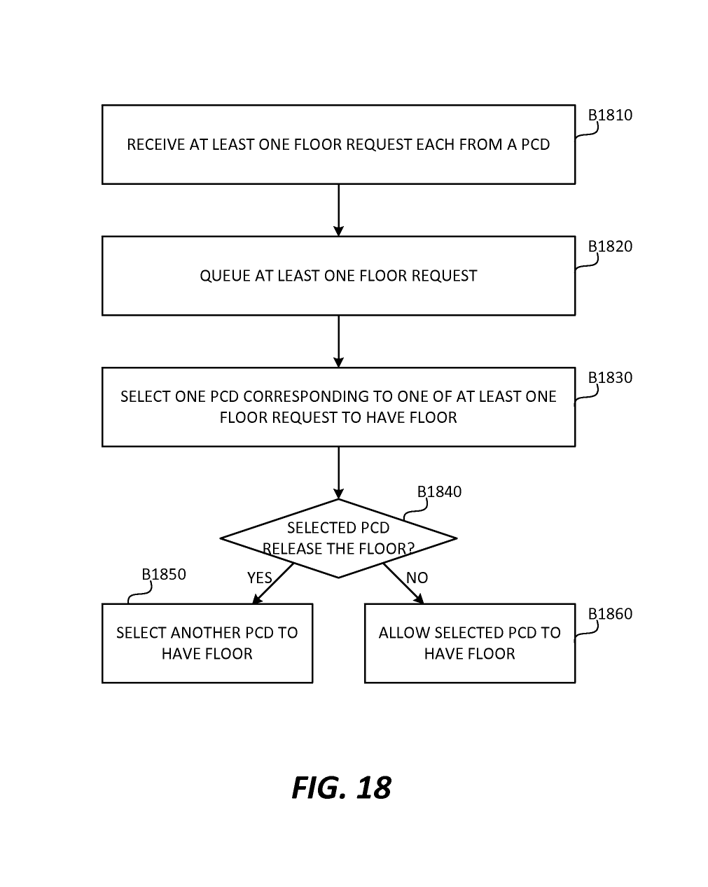

FIG. 18 is a process flowchart illustrating an example of an alternative floor control method 1800 according to various embodiments. Referring to FIGS. 1-18, first at block B1810, the client 130 may receive at least one floor request in a manner such as, but not limited to, block B1710. Next at block B1820, the client 130 may queue the at least one floor request (such as, but not limited to, when the client 130 receives two or more floor requests) in a manner such as, but not limited to, block B1720. Next at block B1830, the client 130 may select one PCD corresponding to one of the at least one floor request to have the floor in a manner such as, but not limited to, block B1730.

Next at block B1840, the client 130 may determine whether the selected PCD has released the floor (such as, but not limited to, no longer assigned to transmit signals). In some embodiments, the user of the selected PCD may indicate via the user interface device 250 that the floor is being released. In some embodiments, the selected PCD, the host 120, and/or the client 130 may automatically determine such release when the energy or amplitude of the output PCD signal 540 is below a predetermined threshold. In some embodiments, a timer is provided (such as, but not limited to, a predetermined amount of time set by an operator of the host 120 or the client 130) that represent an allotted time for each PCD to have the floor. When the timer expires, the selected PCD is determined to have released the floor.

Next at block B1860 (B1840:NO), the client 130 may allow the selected PCD to have the floor when the selected PCD has not yet released the floor. On the other hand, whereas the selected PCD has released the floor (B1840:YES), the client 130 may select another PCD to have the floor at block B1850. The another PCD may correspond to a floor request that is next in the queue.

In various embodiments, a floor request may be displayed via the user interface device 250, the user interface device 350 or the user interface device 450 to be perceived by the operator or the user of the PCD 110 (a PCD different from the origin of the floor request), the host 120, or the client 130 respectively. The floor request may be displayed as a popup window or any other types of visual/audio notification and notify the operator/user of the request. The operator/user may then indicate approval or rejection through the user interface device 250, the user interface device 350, or the user interface device 450.

One of ordinary skills in the art would appreciate that, alternative to the client 130 being the device performing the alternative floor control method 1800 as described herein, the host 120 and/or the server 1630 may, instead, perform the alternative floor control method 1800 in a similar manner.

In some embodiments, the PCD 110 (such as, but not limited to, the user interface device 250) may provide its user an option (configured as a user interactive element) to request instantaneous floor access to join an ongoing conversation. The ongoing conversation may refer to any PCD 110 transmitting data to the client 130 after the floor has been granted (such as, but not limited to, after the establishing of the active participant session 620). When the instantaneous floor access user interactive element provided by the user interface device 250 is selected, the PCD 110 may transmit a request directly to the server (such as, but not limited to, bypassing the host 120 and the client 130). The sever, in response, may automatically grant the instantaneous floor access request to allow the PCD 110 to transmit audio without any operator input at the host 120 or at the client 130. In other embodiments, the instantaneous floor access request may be transmitted to the host 120 or the client 130 for operator approval. For example, the request may be displayed to the user interface device 350 or the user interface device 450 to be perceived by the operator. The operator may then indicate approval or rejection through the user interface device 350 or the user interface device 450.

In some cases, given that media data may be transmitted over a wireless link, it may be foreseeable that an uninvited third-party device could sniff out the port on which the client 130 is receiving the media data and jam the port by sending unsolicited data despite that the third-party device is not an approved device to communicate.

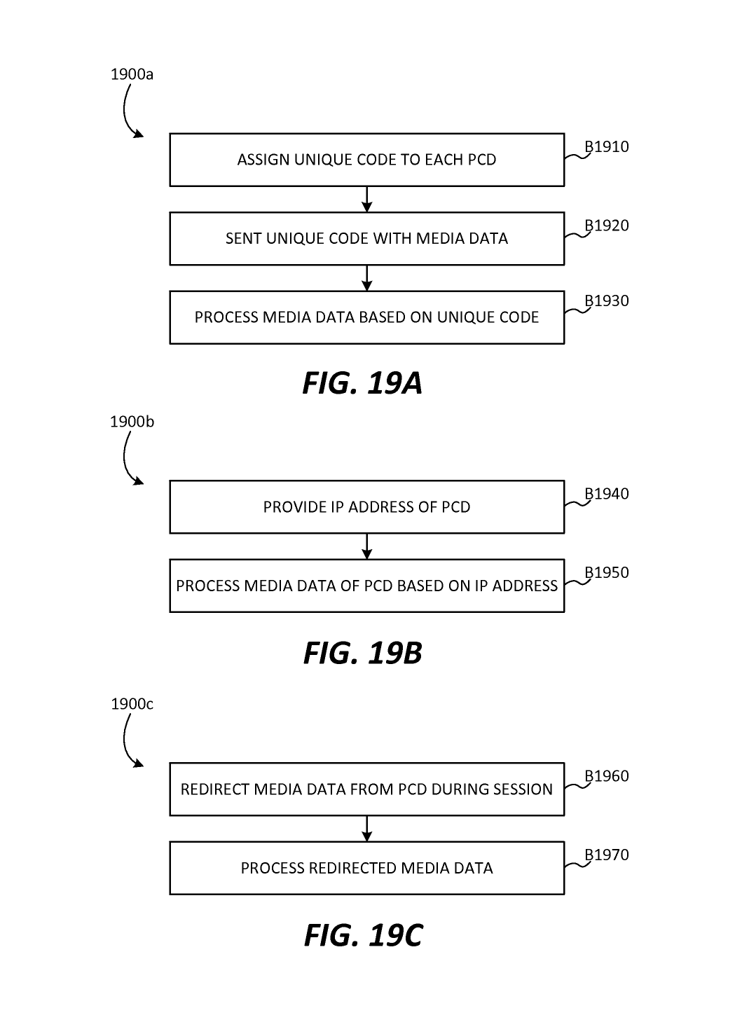

FIG. 19A is a process flowchart illustrating an example of a first jamming prevention method 1900a according to some embodiments. Referring to FIGS. 1-19A, at block B1910, a unique code may be assigned to a PCD 110. The host 120, client 130, or the server 1630 may assign each of the plurality of PCDs 110 a unique code, for example, at a beginning of the active participant session 620. The unique codes may be any pseudo-randomly generated code, or otherwise. The unique codes may be distributed to the host 120 or the client 130 to generate a list of approved PCDs 110. Next at block B1920, the PCD 110 may send its unique code with its media (audio) data (as well as non-audio data) to the client 130. At block B1930, the client 130 may receive the unique code with the media data (as well as the non-audio data) and process the media data based on the unique code. In other words, the client 130 may determine whether the PCD associated with unique code is approved based on the list. The client 130 may only process (such as, but not limited to, any signal processing as described herein) the media data associated with an approved PCD 110.

FIG. 19B is a process flowchart illustrating an example of a second jamming prevention method 1900b according to some embodiments. Referring to FIGS. 1-19B, at block B1940, the host 120 may provide an IP address (or other identifying information) of the PCD 110 to the client 130. A list of approved devices (each identified by a corresponding IP address) may be stored in the host 120, client 130, or server 1630. At block B1950, the client 130 may process media data of the PCD 110 based on the IP address provided by the host 120. In other words, the client 130 may receive the media (audio) data (as well as non-audio data) from the PCD 110 associated with the corresponding IP address. The client 130 may only process (such as, but not limited to, any signal processing as described herein) media data (as well as the non-audio data) from PCD 110 having an IP address identified to be associated with one of the approved devices (ascertained from the list of approved devices).

FIG. 19C is a process flowchart illustrating an example of a third jamming prevention method 1900c according to some embodiments. Referring to FIGS. 1-19C, at block B1960, the host 120 may be configured to redirect media data (as well as non-audio data) from PCD 110 during the active participant session 620, for example, from one client 130 to a different client 130 (where two or more clients 130 may be present in the system), or to a different port of the same client 130. Next at block B1970, the client(s) 130 may be configured to process the redirected media data (as well as the non-audio data).

In some embodiments, the client 130 may encounter various performance issues such as, but not limited to, port jamming, media data packet loss, and/or the like. Restarting the client 130 may be needed from time to time to reset the configurations. In some embodiments, the host 120 may be configured to allow a user of the host 120 (via the user interface device 350) to reset the client 130 with modified configuration. Such modified configuration may include opening a socket with a different port number, and/or the like. Given that the client 130 and the host 120 may be at different nodes of the network 150 and thus at different locations, the client 130 may be remotely reconfigured/restarted by the host 120.

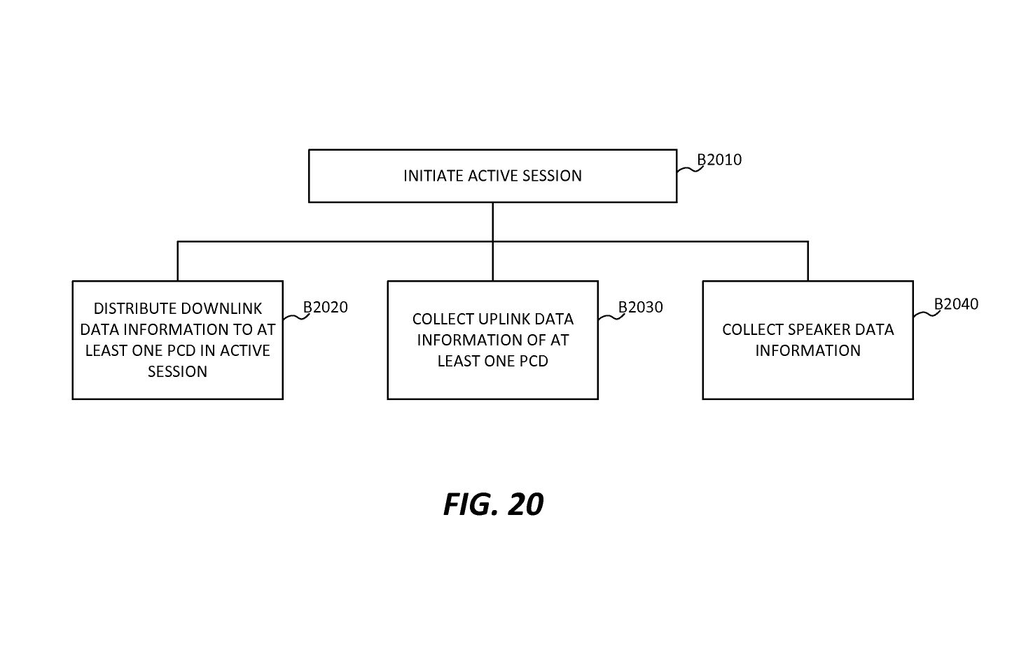

FIG. 20 is a process flowchart illustrating an example of a data collection method 2000 according to various embodiments. Referring to FIGS. 1-20, an active session including a plurality of PCDs (such as, but not limited to, each may be the PCD 110) may be initiated at block B2010. The active session may include the active moderator session 610 and the active participant session 620 between the plurality of PCDs and the client 130. Blocks B2020, B2030, and B2040 may occur simultaneous or sequentially at no particular order following block B2010.

With respect to block B2020, the host 120, the client 130, or the server 1630 may distribute downlink data to the plurality of PCDs in the active session. The downlink data may include, but not limited to, presenter's biography, presentation material, reference sites, advertisement based on the presenter's information or content, and/or the like. In additional embodiments, the at least one PCD may display the downlink data on the user interface device 250 of that PCD to assist the user in the presentation/conference. Such downlink data may be stored in any suitable memory units associated with the host 120 (memory unit 330), the client 130 (memory unit 430), and the server 1630. The downlink data may be collected as uplink data previously, for example, in blocks B2030 and B2040. In other embodiments, the downlink data may be stored, manually inputted, or located otherwise (such as, but not limited to, on the internet) based on the uplink data.

With respect to block B2030, the host 120, the client 130, or the server 1630 may collect uplink data from the at least one PCD in the active session. The at least one PCD may send uplink data to one or more of the host 120, the client 130, or the server 1630. The uplink data may include, but not limited to, audio message, live questions, instance messages, user profile information, profile picture, biography, and/or the like. In some embodiments, the host 120, the client 130, or the server 1630 may send a request to some of the at least one PCD in the active session for uplink data. The PCD(s) may then send such information.

With respect to block B2040, the host 120, the client 130, or the server 1630 may collect speaker data information, which may also be a part of the uplink data. A speaker device may be a PCD that has been, at some point, assigned the floor in the manner described. Speaker data information include, but is not limited to, maker and model of the speaker device, name of user, affiliation of the speaker or the user of the speaker device, audio speech (converted into text), and/or the like originating from the speaker device. With respect to the audio speech that has been converted into text, audio data originating from the speaker device may be recorded and archived at any suitable remote databases for later access.

In some embodiments, the downlink data and the uplink data may be transmitted in such manner even when there is no active participant session 620 established between PCD 110 and the host 120/client 130. Whenever the PCD 110 is connected to the network 150 (such as, but not limited to, after launching an application at device level of the PCD 110 and/or successful registration/authentication with server/host 120/client 130, the downlink data and the uplink data may be collected and/or distributed.

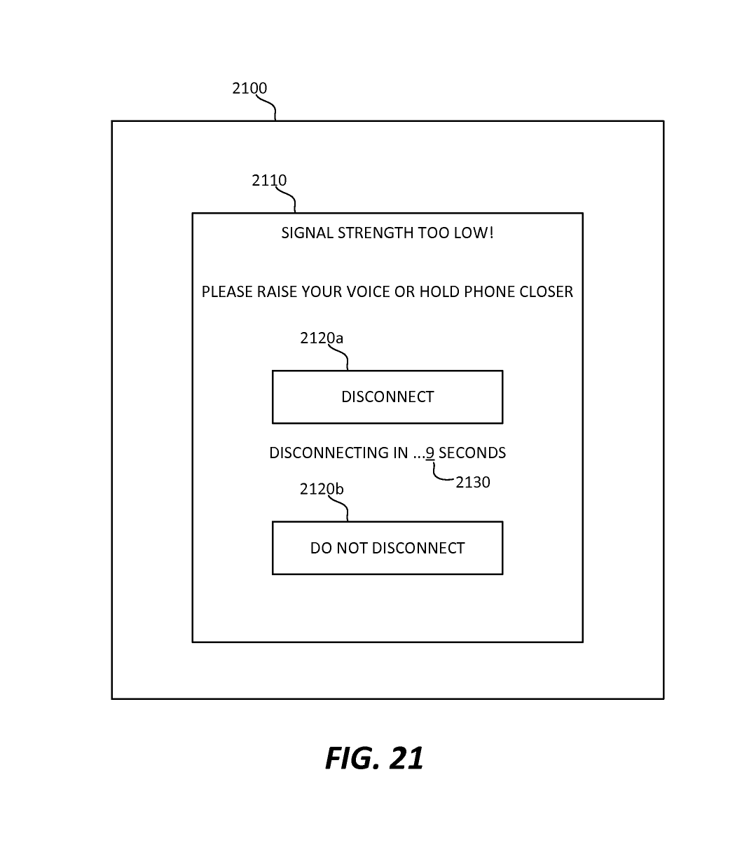

FIG. 21 is an example of a screen shot 2100 informing the user of the PCD 110 the (audio) signal strength is below a tolerance level. Referring to FIGS. 1-21, the client 130 may monitor the signal strength (such as, but not limited to, signal energy) of the PCD output signal 540 and send a request to the PCD 110 when the signal strength is below a predetermined threshold. In response, the PCD 110 may display a pop-up window 2110 notifying the user that the signal strength is below a threshold and prompt the user to either raise his or her voice or hold the PCD 110 closer to the mouth. Where the PCD output signal 540 is below a predetermined threshold, a first user interactive element 2120a may be provided in the pop-up window 2110 such that, when selected, would trigger the PCD 110 to give up the floor (such as, but not limited to, disconnected as the designated speaker). A second user interactive element 2120b may be provided to keep the PCD 110 connected and/or dismiss the pop-up window 2110. In further embodiments, a timer 2130 may be provided such that when the user does not select either the first user interactive element 2120a or the second user interactive element 2120b, the PCD 110 may be automatically disconnected when the timer 2130 expires.

In some embodiments, when the PCD output signal 540 is below a predetermined threshold, the PCD 110 may be deemed to be not a speaker device (or not assigned the floor in other suitable manner described). The microphone 210 of the PCD 110 may then be muted. In some embodiments, the microphone 210 of a first PCD may be muted when a second PCD has been assigned the floor in the manner described.

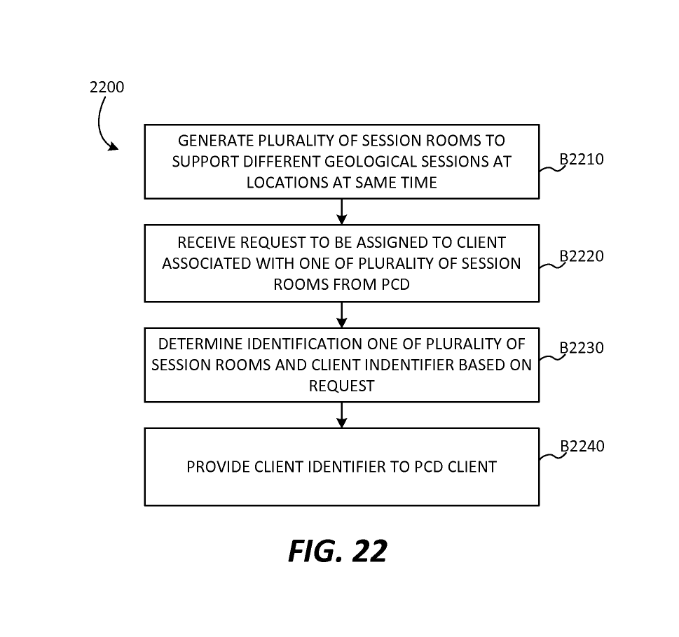

FIG. 22 is a process flowchart illustrating an example of multiple session management method 2200 according to various embodiments. Referring to FIGS. 1-22, first at block B2210, the server 1630 may generate a plurality of session rooms to support a plurality of sessions at different geographical locations at the same time. For example, in a scenario where multiple conferences are taking place at the same time in different conference halls, a client device (such as, but not limited to, the client 130) may be associated with each conference hall. The server 1630 may store data related to each session in separate session rooms (partitions of a memory unit of the server 1630) for individual control.

Next at block B2220, the server 1630 may receive a request from a PCD (such as, but not limited to, the PCD 110) to be assigned to a client device associated with one of the plurality of session rooms. The PCD may be carried by the user to a geographical location (such as, but not limited to, a particular conference hall) to be used there. In other embodiments, the PCD may be a remote device and is not within the boundaries (such as, but not limited to, walls, fences, and the like) of the requested geographical location. The downlink data and the uplink data (as set forth in the data collection method 2000) may be collected, stored, and/or distributed separately for each of the session rooms (such as, but not limited to, stored separately based on each session room). The request may include identification information of the PCD itself or the session identifier identifying a session. Based on the request, the server may determine identification information of one of the plurality of session rooms at block B2230. Given that each of the plurality of session rooms may be associated with a client identifier indicating the identity of the client device 130, the server 1630 may also determine the client identifier (such as, but not limited to, IP address). Next at block B2240, the server may provide the client identifier to the PCD. The PCD may then initiate sessions (such as, but not limited to, the active participant session 620) when granted the floor using the client identifier.

When a plurality of PCDs (each of which may be the PCD 110) are present, typically one client 130 may support active participant session 610 with only one PCD 110 at a given time. As such, multiple PCDs can only take turns to access the PA system 140. In addition, frequent “access-switch” may be required. This is very cumbersome, at the least. Therefore, it is desirable to allow multiple PCDs to access the PA system 140 simultaneously.

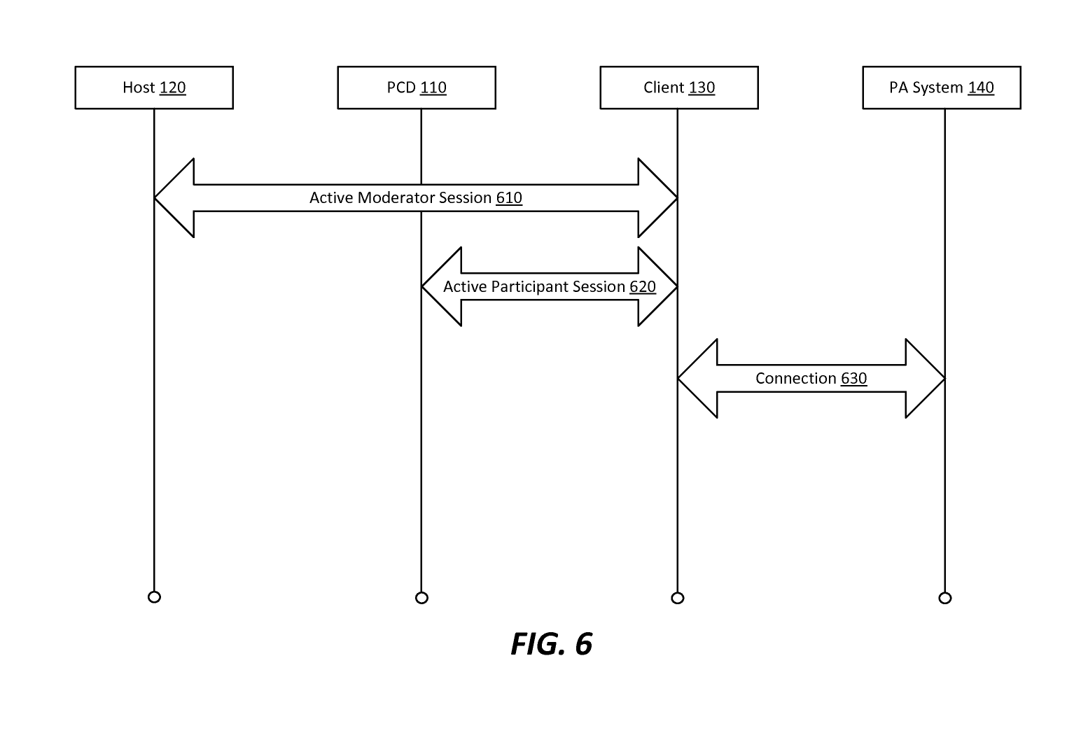

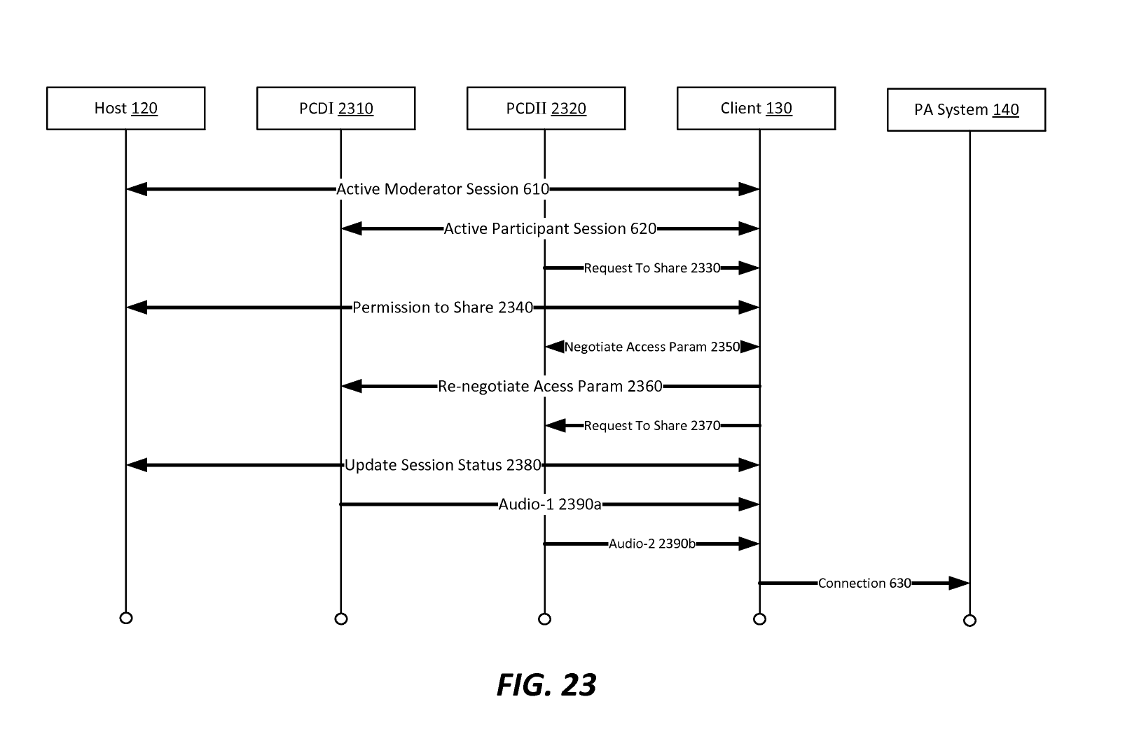

FIG. 23 is diagram illustrating an example of a call flow process 2300 according to various embodiments. Referring to FIGS. 1-23, the call flow process 2300 may be implemented with the host 120, the client 130, the PA system 140, a PCD I 2310, and a PCD II 2320. Each of PCD I 2310 and PCD II 2320 may be the PCD 110 in various embodiments. An active moderator session 610 may be established between PCD I 2310 and the client 130 in the manner described (at least with respect to FIG. 6). The active participant session 620 may be established between PCD I 2310 and the client 130 in the manner described (at least with respect to FIG. 6). The connection 630 may be made between the client 130 and the PA system 140 in the manner described (at least with respect to FIG. 6).

In some embodiments, while PCD I 2310 is already in the active participant session 610 with the client 130, PCD II 2320 may request to access the client 130 (such as, but not limited to, with a request to share 2330). In response to the request to share 2330, the client 130 may seek permission (such as, but not limited to, via the permission to share 2340) from the host 120. The host 120 may respond automatically or manually (via the user interface device 350) with a permission to share the client 130 between PCD I 2310 and the PCD II 2320. In further embodiments, at least one additional PCD may have privilege to join the active participant session 620 without any explicit permission request. That is, the additional PCD may include authentication credentials that, once identified by the client 130, would allow the client 130 to automatically add the additional PCD to the active participant session 620 without further authenticating. Alternatively, the client 130 may receive user input for adding the additional PCD.

In response to the permission to share 2340 being received from the host 120, the client 130 may set up another active participant session by negotiating access parameters 2350 with the PCD II 2320. In some cases, it is likely that PCD I 2310 and PCD II 2320 may have different audio hardware/software processing characteristics. As a result, the client 130 may negotiate with both PCD I 2310 and PCD II 2320 to adjust various parameters of the audio data packets coming from each of PCD I 2310 and PCD II 2320 by negotiating access parameters 2350 with PCD II 2320 and re-negotiating access parameters 2360 with PCD I 2310. The access parameters may include, but are not limited to, sampling rate, sample size, packet size, endian-ness of the samples of the audio data, and the like. This allows the participating PCDs (PCD I 2310, PCD II 2320, as well as other PCDs not mentioned for the sake of clarity) to send audio data packets with similar or the same parameters to be processed by one client 130. The client 130 may also update internal resource allocations and assign a receive queue for each participating PCD in order to receive and store the incoming audio data from the participating PCDs.

In response to successful negotiation with PCD II 2320 and re-negotiation with PCD I 2310, the client 130 may transmit a response to share 2370 to PCD II 2320 verifying the share of the client 130. Next, the session status 2380 may be updated between the host 120 and the client 130, indicating the sharing of the client 130 to the host 120. The host 120 may then be able to activate various control options described herein, including, but not limited to, howling suppression, mute one of the PCDs, and the like (automatically or via the user interface device 350). In response to the session status update 2380, audio data from PCD I 2310 (such as, but not limited to, Audio 1 2390a) and audio data from PCD II 2320 (such as, but not limited to, Audio 2 2390b) may be sent to the client 130 using the renegotiated access parameters. The client 130 may modify and relay the audio data to the PA system 140 via the connection 630. Similarly, non-audio data may also be received from both PCDs simultaneously with the audio data from both PCDs.

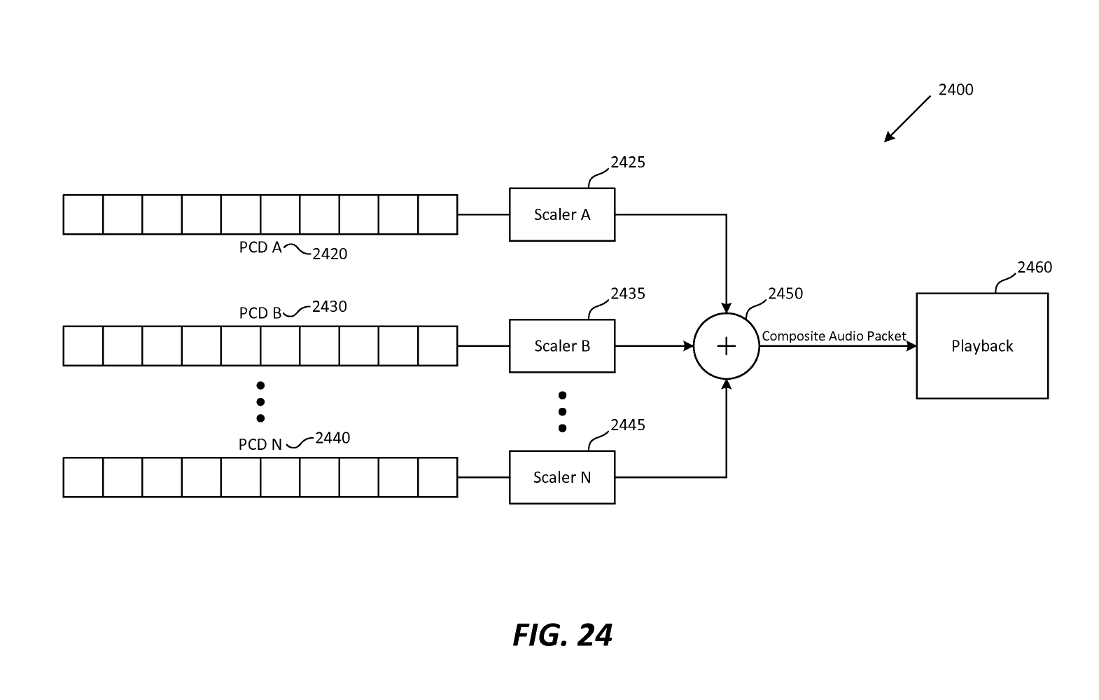

FIG. 24 is a diagram 2400 illustrating an example of a multiple PCD shared access processing according to various embodiments. Referring to FIGS. 1-24, based on the negotiated parameters (e.g. number of samples, sample size, sampling rate, and the like as described with respect to at least FIG. 23), the client 130 may periodically select an audio packet received from each of the participating PCDs (such as, but not limited to, PCD I 2310 andPCD II 2320). The client 130 may then apply dynamically-determined scaling factors to one sample at a time from the each of the selected audio packets and produce a composite audio sample by combining scaled samples from each participating PCD. This composite sample is send to the PA system 140 via the connection 630 for playback. As a result, input from the all (or at least two or more of) the participating PCDs will be played out through the speakers 141 of the PA system 140 simultaneously. The scaling of the samples may control the energy and avoid the possibility of saturation when composite sample is produced.

In a non-limiting example, the multiple PCD shared access processing as set forth in FIG. 24 may include PCD A 2420, PCD B 2430, . . . , and PCD N 2440, each of which may be a PCD such as, but not limited to, the PCD 110. Each PCD may produce samples (such as, but not limited to, 2-byte samples using 16 KHz sampling rate, which produces 128-byte audio packets every 4 ms). The samples may be transmitted as Audio-1 2390a and Audio-2 2390b in some embodiments. The client 130 may select a given audio packet from each PCD in a predetermined period of time (such as, but not limited to, 2 ms, 4 ms, 5 ms, or the like). The client 130 may include scalers (such as, but not limited to, scaler A 2425, scaler B 2435, . . . , and scaler N 2445 implemented with the processor 420) configured to scale a (2-byte or other suitable size) sample from each of the selected audio packets up/down by a predetermined amount (such as, but not limited to, 1.5, 2, 3, 5, or the like). Then, the client 130 may combine (aggregate) the scaled samples into a single composite sample at adder 2450. The composite sample is then sent to playback 2410 (such as, but not limited to, at the PA system 140 via the connection 630). For example, the audio sample of PCD A 2420 is assumed to be 900, the audio sample of PCD B 2430 is assumed to be 30000, and the audio sample of PCD N 2440 is assumed to be 63000 (in an example in which no additional PCDs are present). After scaling (down by a factor of 3), the scaled audio sample of PCD A 2420 is assumed to be 300, the scaled audio sample of PCD B 2430 is assumed to be 10000, and the scaled audio sample of PCD N 2440 is assumed to be 21000. The composite audio packet may be 31300 when outputted by the adder 2450. The client 130 may repeat this process for each audio sample in the selected audio packets at each instance. In other embodiments, the scaling factors may be different for each of the PCD A 2420, PCD B 2430, . . . , and PCD N 2440.

Alternately, multiple clients 130 may be assigned to each PCD in active participant session 620. These clients 130 may each be associated with at least one of the plurality of PCDs. These clients may co-ordinate in a distributed manner and, in some embodiments, with the help trigger from the host 120, to allow multiple PCDs to access the PA system 140 simultaneously. For example, instead of having the scalers 2425, 2435, . . . , 2445 in one client, each of the multiple clients 130 may include its own scaler(s) for scaling different PCDs connected to that client 130. A same or different scaling factor may be negotiated between the multiple clients 130 in advance. An adder (such as, but not limited to, the adder 2450) may be placed in one of the multiple clients 130 or the host 120 to add the audio data from the multiple clients 130 and then transmit the stream to the PA system 140 for sounding.

Accordingly, the shared access as described enables new capacity for the PCD-based PA system 140 (that uses shared wireless medium). Hardware resources may be reduced given that a same client 130 may cater to the plurality of PCDs. Therefore, cost is reduced. The shared access processes may also provide a scalable solution, as the call flow could support many more simultaneous PCDs, which traditional PA system (based on wireless microphones) could not have supported without significant hardware expenses.

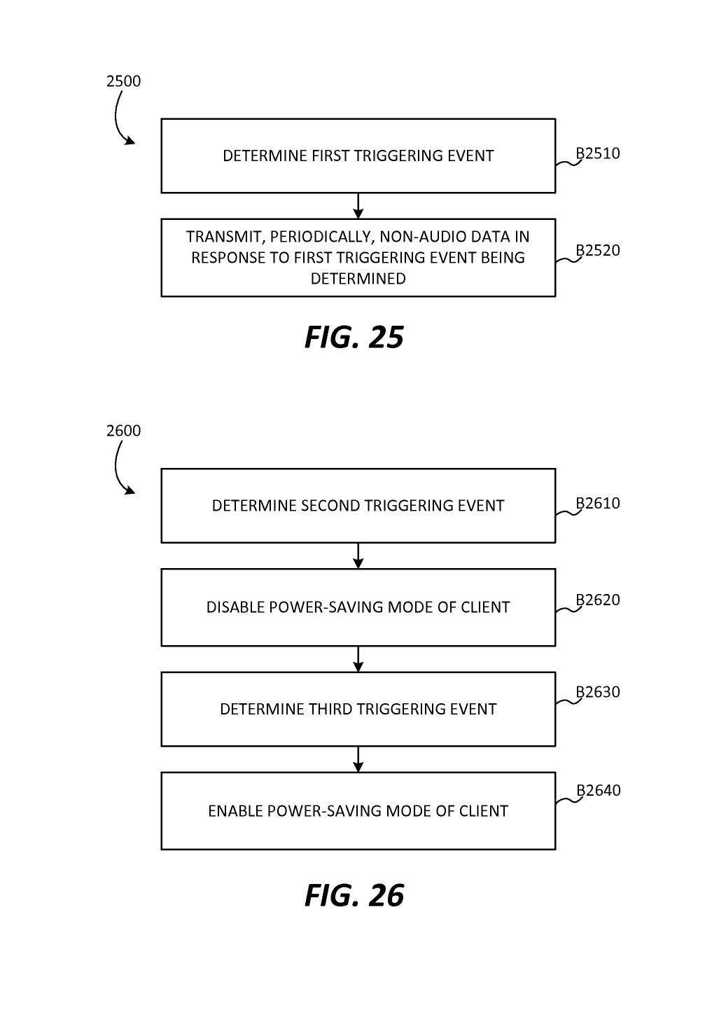

FIG. 25 is a process flowchart illustrating an example of a latency optimization process 2500 according to various embodiments. In some cases, when a PCD 110 and a client 130 are engaged in the active participant session 620 (such as, but not limited to, the PCD 110 has the floor and is engaged in an active call), audio data is transmitted from the PCD 110 to the client 130. Audio transmission latency may be increased when the address resolution protocol (ARP) cache on the PCD 110 times out and a refreshing mechanism to refresh the ARP cache is triggered. This may result in outgoing data traffic form the PCD 110 to transmit a ARP request and interrupt the sending of audio data given that ARP refresh requests are OS processes having a high transmission priority than audio data transmission processes. As such, audio data transmission would experience increased latency. In addition, the client 130 may automatically initiate power-saving mode when audio data is not received for a predetermined period of time. Starting up the client 130 from the power-saving mode may also increase latency for audio data transmission.

Referring to FIGS. 1-25, at block B2510, a first triggering event may be determined. The first triggering may include the PCD 110's position in the queue for floor requests, the PCD 110 being granted the floor, or the like. The first triggering event may be determined by client 130, the host 120, the server, and/or the PCD 110. The host 120, the server, and/or the PCD 110 may send an indication to the client 130, the indication including the triggering event and at the PCD 110's identifier (such as, but not limited to, IP address) when detecting the first triggering event. In embodiments where the client 130 itself detects the first triggering event, the client 130 may ascertain the PCD 110's identifier (such as, but not limited to, by requesting it from the server, the host 120, and/or the PCD 110 itself via other suitable channels).

Next at block B2520, the client 130 may periodically transmit non-audio data (via best effort flows in some embodiments, but QOS follows in others) in response to the first triggering event being detected. In some embodiments, the non-audio data may be transmitted by the client 130 via best effort flows while the audio data may be transmitted by the PCD 110 via QOS flows. Non-audio data may include ping, user datagram protocol (UDP) packets, and/or other meaningful or meaningless data packets. By periodically transferring non-audio data from the client 130 to the PCD 110, the ARP cache does not time out and the client 130 does not enter the power-saving mode. In particular embodiments, where the PCD 110's position in the queue for floor requests is the first triggering event (such as, but not limited to, determined at block B2510), a predetermined time period is determined based on the position in queue. For example, when the PCD 110 reaches a predetermined place (such as, but not limited to, third place) in the queue, the non-audio data may start to be transmitted by the client 130 periodically until the active participant session 620 ends. In some embodiments, the non-audio data may start to be transmitted by the client 130 periodically in response to the active participant session 620 being initiated until the active participant session 620 ends. The non-audio data may be transmitted once every 1 ms, 2 ms, 5 ms, and/or the like.

Accordingly, one of ordinary skill in the art would appreciate that the non-audio data may be transmitted before the audio data is transmitted following the initiation of the active participant session 620. This is true when the first triggering event is the PCD 110's position in the queue. The PCD 110 may trigger ARP processes by transmitting the non-audio data to the client 130. As such, initial ARP cache request stage may be eliminated to prevent initial latency for the audio data, given that ARP cache has already been requested and is kept timed-in due to the transmissions of the non-audio data before the audio data is transmitted.

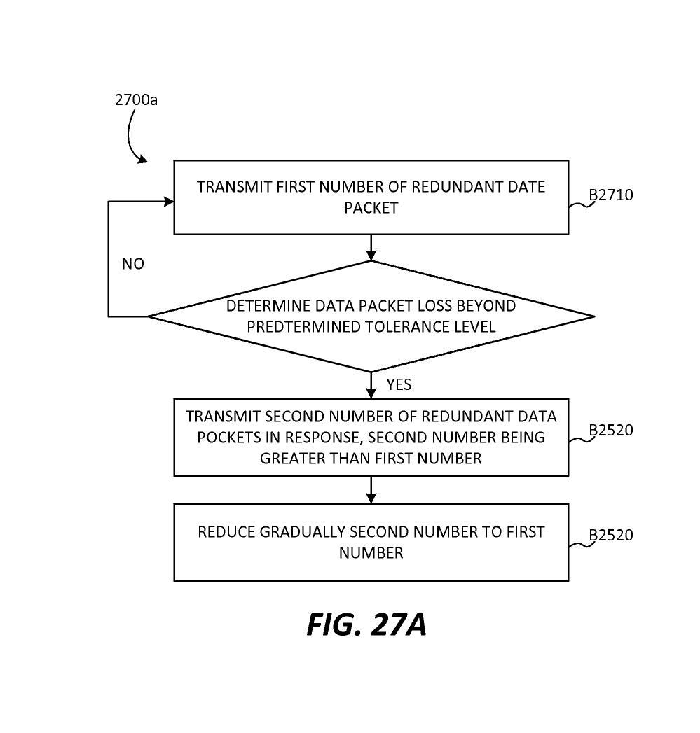

FIG. 26 is a process flowchart illustrating an example of a power-saving mode activation process 2600 according to various embodiments. As described, when the client 130 enters the power-saving mode, audio transmission latency increases due to the time it would take or the client 130 to wake up from the power-saving mode to transmit the downlink data. Typically the client 130 enters the power-saving mode when no data is being transmitted or received for a predetermined power of time. In some embodiments, the power-saving mode is disabled entirely to assure minimal latency to the sacrifice of power consumption.

Now referring to FIGS. 1-26, a second triggering event is determined in block B2610. In some embodiments, the second triggering event may be the launching of an application instructing the client 130 to perform its functions described herein. In other embodiments, the second triggering event may be the floor is granted to a PCD 110. In response to the floor being granted the PCD 110, the entity granting the floor (such as, but not limited to, the server or the host 120) as well as the PCD 110 itself may transmit any indication of the occurrence of the second triggering event to the client 130.

Next at block B2620, the client 130 may disable the power-saving mode. For example, the client 130 may call an application programming interface (operating system or WLAN firmware) to disable the power-saving mode on the client 130. Next at block B2630, a third triggering event may be determined. In some embodiments, the third triggering event may be the shutting off of the application for the client 130. In some embodiments, the third triggering event the host 120 sending a an indication to enable the power saving mode of the client 130. An operator manning the host 120 may use the user interface 350 to input the indication to be transmitted over the network 150 to the client 130. In other embodiments, the third triggering event may be the floor being assigned to another PCD. The third triggering event may be detected by the client 130, the PCD 110, the host 120, and/or the server. In response to block B2630, the client 130 may enable or re-enable the power-saving mode of the client 130.

In various embodiments, vocoders may be used to encode and decode the audio data described herein. Given that a typical frame interval is 20 ms, the audio transmission delay may be affected by the 20 ms frame generation/playout delay associated with using the vocoders. In other embodiments, the audio frames may transmitted without vocoding pulse-code modulation (PCM) frames transmitted to reduce delays associated with encoding/decoding. As such, latency may further be reduced given that the audio frames are being transmitted more frequently than 20 ms per frame.

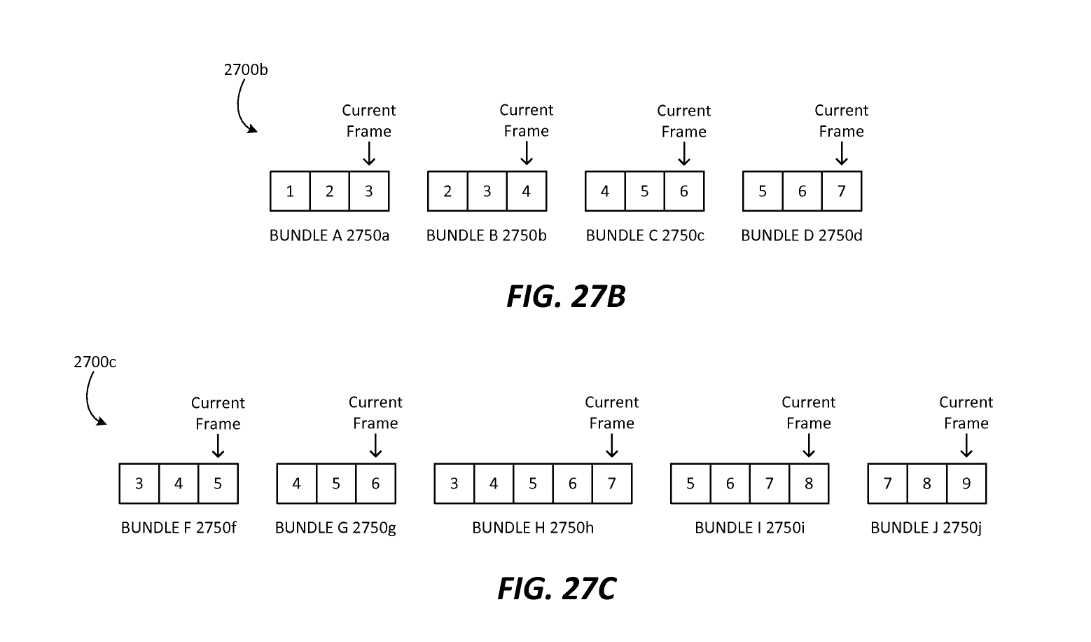

FIG. 27A is a process flowchart illustrating an example of a data packet loss optimization method 2700a according to various embodiments. FIG. 27B is a diagram 2700b illustrating an example of a redundant transmission scheme with a same number of packets being transmitted at each bundle. FIG. 27C is a diagram 2700c illustrating an example of a redundant transmission scheme with dynamically changing numbers of packets being transmitted at each bundle.

Referring to FIGS. 1-27C, even though evenly distributed audio data packet loss up to 15% is not likely to be noticeable by human ear, contiguous packet loss may be noticeable. In some embodiments, sending redundant audio data packets such as set forth in the diagram 2700b may seek to minimize loss by providing backup copies of previous frames audio data packets at a current frame. For example, each of bundle A 2750a, bundle B 2750b, bundle C 2750c, and bundle D 2750d may include 3 frames. Each frame may be associated with a frame index value. A frame associated with a smaller frame index value may be attempted to be transmitted before a frame with a larger frame index value. The frame with the largest index (such as, but not limited to, frame [3] in bundle A 2750a) is the current frame, as indicated. The larger than number of frames included the bundle (the more the previous frames included), the less than audio data packet loss. On the other hand, whereas the number of frames included in a given bundle is large, processing time and transmission time may increase latency. The client 130 may use the previous frames (redundant frames) as backup frames and play them in case there is a loss of data occurring at one of the redundant frames when it was transmitted the first time.

In other embodiments, instead of having the number of previous frames remain constant, a dynamic process (such as, but not limited to, the data packet loss optimization method 2700a) may be implemented to increase the number of previous frames when needed (intolerable loss) and reduce the number of previous frames when little or no loss has been detected. Such system and process assures low data loss while improves latency.

First at block B2710, the PCD 110 may transmit a first number of redundant (audio) data packets to the client 130. In some embodiments, the first number may be an optimized number that minimizes latency and while providing sufficient coverage for occasional or non-continuous loss of data packets. Next at block B2720, the PCD 110, the client 130, the host 120, and/or the server may determine whether data packet loss is beyond a predetermined tolerance level. The predetermined tolerance level may be a number of total data packets lost a number of continuous data packet lost, or a combination thereof. The client 130, as the receiving device, may determine the number of data packet loss and transmit it to the PCD 110, the host 120, and/or the sever.

Whereas data packet loss is not beyond the predetermined tolerance level (B2720:NO), the data packet loss optimization method 2700a returns to block B2710. On the other hand, whereas it is determined that the data packet loss is beyond the predetermined tolerance level, the 110 may transmit a second number of redundant data packets in response, the second number is greater than the first number, at block B2730 (B2720:YES). As such, the number of redundant data packets is increased to extend backtracking to recover lost data packets.

Next at block B2740, the PCD 110 may reduce, gradually, the second number to the first number over a predetermined number subsequent frames. Given that a burst redundant data packets are commissioned to recover lost data packets, subsequent frames need not to adhere to the second number (unless another data packet loss is beyond predetermined tolerance level); the number of redundant frames may return to its optimal number (such as, but not limited to, the first number). For example, a first subsequent frame may include a third number of redundant frames, the third number being between the first number and the second number.

In the non-limiting example illustrated in FIG. 27C, the data packet loss may be determined to be beyond the predetermined tolerance level (B2720:YES) at frame 6 (i.e., after bundle G 2750g). Thus, bundle H 2750h may include an increased number of redundant data packets (such as, but not limited to, 4 instead of 2) to recover lost data packet. The number of redundant frames of subsequent frames may gradually be reduced to the first number (such as, but not limited to, 2). For example, the number of redundant frames for bundle I 2750i is 3, and the number of redundant frames for bundle J 2750j is 2 (such as, but not limited to, the first number).

In some embodiments, a PCD 110 may be determined to be a remote device connected to the network 150 based on geographical data (as determined by geolocation, IP address, user input, and/or the like). For example, the PCD 110 may be determined to be a remote device if it is not within a predetermined area (such as, but not limited to, a conference hall). A remote device may function as a PCD 110 in requesting the floor, establish active sessions for data transmission, and/or other functions described herein.

It should be appreciated that the PCD-based PA systems as described herein may be implemented for events, conferences, universities for classes, meetings, and even for ad hoc events, etc.

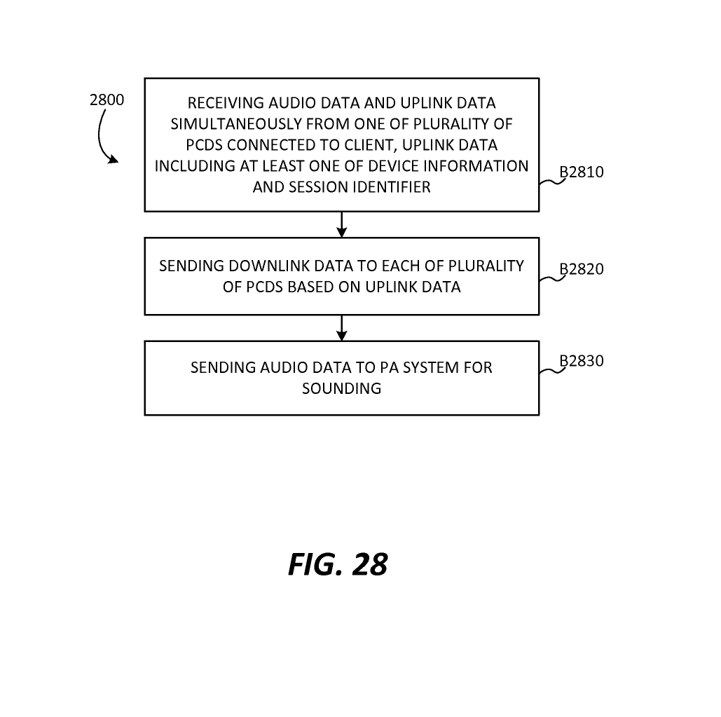

FIG. 28 is a process flowchart illustrating an example of a data communication method 2800 according to various embodiments. Referring to FIGS. 1-28, the client 130 may receive (with the network device 440 as coupled to the processor 420) audio data and uplink data simultaneously from one of a plurality of PCDs (each of which may be the PCD 110) connected to the client 130, at block B2810. The one of the plurality of PCDs may be selected to have the floor in the manner described. A user of the one of the plurality of PCDs may be the presenter who has the floor. For example, the audio data and the uplink data may be received during the active participant session 620. The uplink data may include, for example, an audio message, live questions, instance messages, user profile information, profile picture, biography, and/or the like. The uplink data may also include the maker and model of the speaker device, name of user, affiliation of the speaker or the user of the speaker device, audio speech (converted into text), and/or the like. The uplink data may be audio data and/or non-audio data. The audio data may be the PCD output signal 540. The session identifier may identify one of the plurality of sessions corresponding to different geographical locations in the matter described.

At block B2820, the client 130 may send (with the network device 440 as coupled to the processor 420) downlink data to each of the plurality of PCDs based on the uplink data. For example, the client 130 may send the downlink data to the PCDs associated with a same session (as indicated by the same session identifier). In other words, the downlink data may only be sent to PCDs having the same session identifier, indicating that the PCDs are within boundaries of a same geographical location (such as, but not limited to, a same conference hall) or otherwise grouped in a same group. The downlink data may include at least the presenter's biography, presentation material, reference sites, advertisement based on the presenter's information, or advertisement based on the presentation content. The downlink data may be selected or otherwise used based on the uplink data in the manner described. For example, upon receiving the uplink data, the client 130 may extract key information from the received uplink data. The key information may include the presenter's name (extracted from the name of the user or the user profile), the presenter's associated company (extracted from the affiliation of the presenter), and the like. Based on the extracted key information, the client 130 may search in the memory unit 430 of the client 130, the memory unit 340 of the host 120, of the storage of the server 1630 for corresponding stored downlink data previously stored (such as, but not limited to, presentation material, presenter's information and biography, advertisement previously stored, and the like) using the extracted key information. Alternatively, the uplink data may be pushed by the client 130 to the plurality of PCDs as downlink data directly. In other or further embodiments, the client 130 may search the internet for the downlink data (such as, but not limited to, advertisement, additional information on the presenter, and the like). At block B2830, the client 130 may send (with the network device 440 as coupled to the processor 420) the audio data to the PA system for sounding. Blocks B2820 and B2830 may occur simultaneously or in any sequential order.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, components, circuits, and algorithm steps described in connection with the embodiments disclosed herein may be implemented as electronic hardware, computer software, or combinations of both. To clearly illustrate this interchangeability of hardware and software, various illustrative components, blocks, components, circuits, and steps have been described in this disclosure generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, such as, but not limited to, a combination of a DSP and a microprocessor, a plurality of microprocessors, at least one microprocessors in conjunction with a DSP core, or any other such configuration.

The steps of a method or algorithm described in connection with the embodiments disclosed herein may be embodied directly in hardware, in a software component executed by a processor, or in a combination of the two. A software component may be provided in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor may read information from, and write information to, the storage medium. In the alternative, the storage medium may be integral to the processor. The processor and the storage medium may be provided in an ASIC. The ASIC may be provided in a user terminal. In the alternative, the processor and the storage medium may be provided as discrete components in a user terminal.

In at least one exemplary embodiments, the functions described may be implemented in hardware, software, firmware, or any combination thereof. If implemented in software, the functions may be stored on or transmitted over as at least one instructions or code on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to carry or store desired program code in the form of instructions or data structures and that may be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The attached Appendix is incorporated herein by reference in its entirety. The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method for data communication in a Public Address (PA) system, comprising:
receiving, by a client, host, or server, audio data and uplink data simultaneously from one of a plurality of Personal Communication Devices (PCDs) connected to the client, wherein the uplink data comprises at least one of device information and session identifier;
sending, by the client, host, or server, downlink data to each of the plurality of PCDs based on the uplink data; and
sending, by the client, host, or server, the audio data to the PA system for sounding.

2. The method of claim 1, wherein the PA system is at least one of (1) a Peer-to-Peer (P2P) system without a centralized server or host, or (2) a system with centralized control by the server or the host.

3. The method of claim 1, further comprising:
establishing, by the client, host, or server, an active participant session with a first PCD of the plurality of PCDs;
receiving, by the client, host, or server, a request to share from a second PCD of the plurality of PCDs;
negotiating, by the client, host, or server with the first and second PCDs, access parameters after receiving the request to share; and
receiving, by the client, host, or server, the audio data based on the negotiated access parameters from both the first PCD and the second PCD.

4. The method of claim 3, further comprising:
sending, by the client to a host, a request for permission to share in response to receiving the request to share from the second PCD;
negotiating the access parameters in response to receiving, by the client, an indication indicating permission from the host to share the client;
accepting, by the client, a request for permission to share from a third PCD without negotiating the access parameters based on user input or automatically.

5. The method of claim 4, further comprising updating, by the client with the host, a session status, wherein the audio data from the first PCD and the second PCD is received by the client in response to sessions status being updated.

6. The method of claim 3, further comprising:
combining, by the client, host, or server, the audio data received from both the first PCD and the second PCD;
outputting the combined audio data to the PA system for sounding; and
scaling, by the client, host, or server, the audio data received from both the first PCD and the second PCD before combining the audio data.

7. The method of claim 1, further comprising:
selecting, by the client, host, or server, the one of the plurality of PCDs from the plurality of PCDs;
starting, by the client, host, or server, a data inactivity timer that counts down when energy associated with the audio data of the selected PCD is below a predetermined threshold;
notifying, by the client, host, or server, that the data inactivity timer is about to expire;
selecting, by the client, host, or server, another one of the plurality of PCDs, automatically or based on user input, when the data inactivity timer expires; and
continuing to receive, by the client, host, or server, the audio data of the selected PCD when time on the data inactivity timer is unexpired.

8. The method of claim 7, further comprising:
notifying, by the client, host, or sever, the one of the plurality of PCDs to disconnect from the active participant session when the energy is below a predetermined threshold; and
either of:
requesting, by the client, host, or server, the one of the plurality of PCDs to mute a microphone of the one of the plurality of PCDs when the energy is below a predetermined threshold; or
muting, by the one of the plurality of PCDs, the microphone without any indication from the client, host, or server.

9. The method of claim 7, further comprising:
increasing, by the client, host, or sever, a time left on the data inactivity timer when the energy associated with the audio data is above a predetermined threshold; and
freezing, by the client, host, or sever, the time left on the data inactivity timer when the energy associated with the audio data is above a predetermined threshold.

10. The method of claim 7, further comprising dropping, by the client, host, or sever, audio data from another one of the plurality of PCDs before the data inactivity timer expires.

11. The method of claim 7, further comprising:
receiving, by the client, host, or sever, an indication from the selected PCD to release a floor; and
selecting another one of the plurality of PCDs in response to receiving the indication either automatically or based on user input.

12. The method of claim 1, further comprising:
assigning, by the client, host, or sever, a unique code for each of the plurality of PCDs, the unique codes indicate approved devices;
receiving, by the client, host, or sever, the audio data and the uplink data with the unique code associated with the one of the plurality of PCDs; and
processing, by the client, host, or sever, the audio data and the uplink data when the received unique code is determined to be associated with one of the approved devices.

13. The method of claim 1, further comprising:
determining, by the client, host, or sever, an Internet Protocol (IP) address for each of the plurality of PCDs, the IP address indicate approved devices;
receiving, by the client, host, or sever, the audio data and the uplink data with the IP address with the one of the plurality of PCDs; and
processing, by the client, host, or sever, the audio data and the uplink data when the received IP address is determined to be associated with one of the approved devices.

14. The method of claim 1, further comprising redirecting the audio and the uplink data from one port to another port of the client.

15. The method of claim 1, further comprising:
receiving, by the client from a host, a request to reset; and
resetting the client in response to the request to reset.

16. The method of claim 1, further comprising:
receiving, by the client from a host, a request to modify configurations; and
modifying the configurations of the client in response to the request to modify, wherein the configurations modified comprise opening a socket with a different port number.

17. The method of claim 1, wherein the downlink data comprises at least one of a presenter's biography, presentation material, reference sites, advertisement based on the presenter's information, or advertisement based on the presentation content, wherein the presenter is a user of the one of the plurality of PCDs.

18. The method of claim 17, further comprising receiving, by the client, host, or sever from the one of the plurality of PCDs, the uplink data stored on the one of the plurality of PCDs, wherein the uplink data received by the client correspond to the downlink data.

19. The method of claim 18, wherein the uplink data comprises at least one of audio message, live questions, instance messages, user profile information, profile picture, or biography.

20. The method of claim 18, wherein the uplink data comprise at least one of a maker of the one of the plurality of PCDs, model of the one of the plurality of PCDs, name of a user of the one of the plurality of PCDs, affiliation of the user of the one of the plurality of PCDs, or audio speech converted into text.

21. The method of claim 1, wherein the client comprises a plurality of client devices, each client device associated with a separate geographical location, the method further comprises associating the one of the plurality of PCDs with one of the plurality of client devices based on the session identifier.

22. The method of claim 1, wherein the session identifier is a request to join a session at a desired geographical location as indicated by the session identifier.

23. The method of claim 22, further comprising providing, by a server, a client identifier identifying the client device associated with the desired geographical location indicated by the session identifier.

24. The method of claim 21, wherein the one of the plurality of PCDs is not within the boundaries of the desired geographical location.

25. The method of claim 1, further comprising:
receiving a floor request from two or more of the plurality of PCDs;
queuing the floor requests based on time received;
determining a position in queue of the one of the plurality of PCDs; and
sending the position to the one of the plurality of PCDs for displaying to a user of the one of the plurality of PCDs.

26. A system for data communication in a Public Address (PA) system, comprising:
means for receiving audio data and uplink data simultaneously from one of a plurality of Personal Communication Devices (PCDs), wherein the uplink data comprises at least one of device information and session identifier;
means for sending downlink data to each of the plurality of PCDs based on the uplink data; and
means for sending the audio data to the PA system for sounding.

27. A non-transitory computer-readable medium comprising computer-readable instructions such that, when executed, causes a processor to:
receive audio data and uplink data simultaneously from one of a plurality of Personal Communication Devices (PCDs), wherein the uplink data comprises at least one of device information and session identifier;
send downlink data to each of the plurality of PCDs based on the uplink data; and
send the audio data to the PA system for sounding.

28. The non-transitory computer-readable medium of claim 27, the processor is further configured to:
establish an active participant session with a first PCD of the plurality of PCDs;
receive a request to share from a second PCD of the plurality of PCDs;
negotiate with the first and second PCDs access parameters after receiving the request to share; and
receive the audio data based on the negotiated access parameters from both the first PCD and the second PCD.

29. The non-transitory computer-readable medium of claim 28, the processor is further configured to:
send a request for permission to share in response to receiving the request to share from the second PCD; and
negotiate the access parameters in response to receiving an indication indicating permission from the host to share the client.

30. The non-transitory computer-readable medium of claim 29, the processor is further configured to update a session status, wherein the audio data from the first PCD and the second PCD is received in response to sessions status being updated.
